(19) United States
(12) Patent Application Publication
(10) Pub. No.: US 2025/0383459 A1
(43) Pub. Date: Dec. 18, 2025

(54) RADIATION DETECTOR, INTEGRATED CIRCUIT, AND RADIATION DETECTION METHOD

(71) Applicant: HAMAMATSU PHOTONICS K.K., Hamamatsu-shi, Shizuoka (JP)

(72) Inventors: Minoru ICHIKAWA, Hamamatsu-shi, Shizuoka (JP); Kazuki FUJITA, Hamamatsu-shi, Shizuoka (JP); Takumi MARUYAMA, Hamamatsu-shi, Shizuoka (JP)

(73) Assignee: HAMAMATSU PHOTONICS K.K., Hamamatsu-shi, Shizuoka (JP)

(21) Appl. No.: 18/878,759

(22) PCT Filed: Jun. 28, 2023
(86) PCT No.: PCT/JP2023/023981

§ 371 Date: Dec. 24, 2024

(30) Foreign Application Priority Data
Jul. 20, 2022 (JP) 2022-115539

(51) Int. Cl. G01T 1/24

(52) U.S. Cl. CPC G01T 1/247

(57) ABSTRACT

A radiation detector includes a plurality of pixel circuits each of which is provided corresponding to each of a plurality of pixels arranged along a predetermined direction and has at least one detection system configured to read out carriers from the corresponding pixel. The at least one detection system includes a counter counting the number of radiation hits, a first register holding first data which is a count value of the counter, a second register holding second data, an adder adding the first data and the second data to generate third data, and a third register holding the third data. The second data is the third data transferred from the third register of the pixel circuit provided corresponding to the pixel adjacent to the corresponding pixel in each of the plurality of pixel circuits.

### TECHNICAL FIELD

An aspect of the present disclosure relates to a radiation detector, an integrated circuit, and a radiation detection method.

### BACKGROUND ART

A radiation detector is known which includes a conversion unit including a plurality of pixels that generate carriers in response to incident radiation and are arranged in a predetermined direction, and a plurality of pixel circuits (integrated circuits) that are provided corresponding to the plurality of pixels, respectively, and read out carriers from the corresponding pixels (see, for example, Patent Literatures 1 to 3). In the radiation detector, the plurality of pixel circuits are connected to each other, and each pixel circuit reads out the number of radiation hits counted by a counter in the pixel circuit in the previous stage and loads the count value to the counter in each pixel circuit. Then, each pixel circuit adds the number of hits newly counted by the counter in the pixel circuit and the loaded number of hits in the pixel circuit in the previous stage. Each pixel circuit sequentially performs this operation to achieve a time delay integration (TDI) operation.

### CITATION LIST

### Patent Literature

Patent Literature 1: Japanese Patent No. 4532743
Patent Literature 2: Japanese Unexamined Patent Publication No. 2009-540282
Patent Literature 3: Japanese Unexamined Patent Publication No. 2014-93616

### SUMMARY OF INVENTION

### Technical Problem

However, in the radiation detectors described in Patent Literatures 1 to 3, a period required for loading is a non-operation period of the counter, and the operation of counting the number of radiation hits is stopped during the period. As the non-operation period of the counter is longer, the radiation detection efficiency of the radiation detector is lower.

An object of an aspect of the present disclosure is to provide a radiation detector, an integrated circuit, and a radiation detection method with improved radiation detection efficiency.

### Solution to Problem

According to an aspect of the present disclosure, there is provided [1] “a radiation detector including: a conversion unit including a plurality of pixels generating carriers in response to incident radiation, the plurality of pixels being arranged along a predetermined direction; and a plurality of pixel circuits each of which is provided corresponding to each of the plurality of pixels and has at least one detection system configured to read out the carriers from a corresponding pixel of the plurality of pixels, in which the at least one detection system includes: a comparator comparing a first signal based on an amount of the carriers with a threshold value and outputting a second signal when the first signal exceeds the threshold value; a counter counting the number of second signals, each of which is the second signal; a first register holding first data which is a count value of the counter; a second register holding second data; an adder adding the first data and the second data to generate third data; and a third register holding the third data, and the second data is the third data transferred from the third register of a pixel circuit provided corresponding to a pixel adjacent to a corresponding pixel of the plurality of pixels in each of the plurality of pixel circuits”.

In the radiation detector described in [1], the detection system of each of the plurality of pixel circuits has the second register, the adder, and the third register. The second register holds, as the second data, the third data transferred from the third register in the pixel circuit provided corresponding to the pixel adjacent to the corresponding pixel. The adder adds the first data, which is the count value of the counter, and the second data to generate the third data. The third register holds the generated third data. This configuration makes it unnecessary to write (load) the count value in the pixel circuit in the previous stage to the counter of each pixel circuit. Therefore, it is possible to shorten the non-operation period of the counter. As a result, it is possible to increase the proportion of the operation period of the counter in each pixel circuit, that is, the period during which the radiation can be detected, to the entire operation period of the pixel circuit. In addition, when the first register is not provided, there is a problem in that it is not possible to update the count value until the count value is held in the register (for example, the third register) in the subsequent stage and the operation of the counter is stopped during that time. By provision of the first register, this problem does not occur. Therefore, it is possible to shorten the non-operation period of the counter. As described above, according to the radiation detector described in [1], since the proportion of the period during which the radiation can be detected to the entire operation period is increased, it is possible to provide the radiation detector with improved radiation detection efficiency.

According to another aspect of the present disclosure, [2] “in the radiation detector according to [1], the adder may include at least one of the first register, the second register, and the third register, and the at least one detection system may have other registers excluding the at least one of the first register, the second register, and the third register outside the adder”.

According to still another aspect of the present disclosure, [3] “in the radiation detector according to [1] or [2], in each of the plurality of pixel circuits, an area of a first region occupied by an analog circuit including the comparator may be larger than an area of a second region occupied by a digital circuit including the counter, the first register, the second register, the adder, and the third register”. In the first region, in some cases, at least one of the size of an element and a mounting interval between the elements is changed in order to suppress a variation in characteristics of each element. According to the radiation detector described in [3], since the area of the first region is large, it is possible to improve flexibility in the design of the analog circuit. In addition, according to the radiation detector described in [1], it is possible to relatively easily configure the function of transferring the third data between the pixel circuits (the TDI function in the digital circuit). Therefore, as in the radiation detector described in [3], it is possible to reduce the area of the digital circuit.

According to yet another aspect of the present disclosure, [4] “in the radiation detector according to [3], the area of the first region may be equal to or larger than half of an entire area of each of the plurality of pixel circuits”. According to the radiation detector described in [4], since the area of the first region is large, it is possible to improve flexibility in the design of the analog circuit.

According to still yet another aspect of the present disclosure, [5] “in the radiation detector according to any one of [1] to [4], each of the plurality of pixel circuits may have a plurality of detection systems as the at least one detection system, and threshold values in the plurality of detection systems, each of which is the threshold value of the comparator, may be different for each detection system”. According to the radiation detector described in [5], the energy level of the radiation (the amount of carriers generated) can be separately detected by each detection system.

According to yet still another aspect of the present disclosure, [6] “in the radiation detector according to [5], adders in the plurality of detection systems, each of which is the adder, may be individually provided for each detection system”. According to the radiation detector described in [6], the plurality of detection systems can perform a detection process in parallel. Therefore, it is possible to improve a processing speed.

According to still yet another aspect of the present disclosure, [7] “in the radiation detector according to [5], the adder in each of the plurality of detection systems may be common to the plurality of detection systems”. According to the radiation detector described in [7], since the common adder is used, it is possible to reduce the area of the circuit.

According to yet still another aspect of the present disclosure, [8] “in the radiation detector according to any one of [1] to [7], the number of bits of the second register may be equal to or larger than a sum of the number of bits of the first register and the number of bits which is a binary representation of the number of the plurality of pixel circuits, and the number of bits of the adder may be equal to the number of bits of the second register”. According to the radiation detector described in [8], since the number of bits of the adder is equal to the number of bits of the second register, it is possible to perform an addition process for each bit in parallel. Therefore, it is possible to improve the processing speed.

According to still yet another aspect of the present disclosure, [9] “in the radiation detector according to any one of [1] to [8], the number of bits of the second register may be equal to or larger than a sum of the number of bits of the first register and the number of bits which is a binary representation of the number of the plurality of pixel circuits, the number of bits of the adder may be smaller than the number of bits of the second register, and the adder may repeatedly perform an operation of adding some bits of the first data in the first register and some bits of the second data in the second register corresponding to the some bits of the first data and outputting a result of the adding until all of the bits of the first data are added”. According to the radiation detector described in [9], since the number of bits of the adder is smaller than the number of bits of the second register, it is possible to reduce the area of the circuit. Meanwhile, the adder repeatedly performs the operation of adding some bits of the first data and some bits of the second data and outputting the result of the addition until all of the bits of the first data are added. This makes it possible to perform the addition process even when the number of bits is small.

According to yet still another aspect of the present disclosure, “in the radiation detector according to [9], the number of bits of the adder may be one, and the adder may have a fourth register for holding a carry signal”. According to the radiation detector described in [10], it is possible to reduce the area of the circuit and to perform carry calculation even when the number of bits of the adder is only one.

According to still yet another aspect of the present disclosure, “in the radiation detector according to any one of [1] to [10], each of the plurality of pixel circuits may further include a charge sharing countermeasure circuit that, when the carriers generated by an incidence of the radiation are dispersively read out to two or more of pixel circuits of the plurality of pixel circuits, determines a pixel of the plurality of pixels corresponding to a position where the radiation is incident and corrects and evaluates the amount of carriers in the pixel, or ignores the incidence of the radiation”. According to the radiation detector described in [11], it is possible to suppress a reduction in energy resolution and the blurring of an image caused by charge sharing.

According to yet still another aspect of the present disclosure, “in the radiation detector according to any one of [1] to [11], the plurality of pixel circuits may further include a switching unit for switching between an operation of transferring the third data along the predetermined direction and an operation of transferring the third data along a direction opposite to the predetermined direction”. According to the radiation detector described in [12], the plurality of pixel circuits can transfer data in both directions.

According to still yet another aspect of the present disclosure, “in the radiation detector according to any one of [1] to [12], each of the plurality of pixel circuits may further include a shaper circuit provided in a stage preceding the comparator, and the shaper circuit may reduce a time constant of the first signal”. According to the radiation detector described in [13], the shaper circuit can increase a response speed of the comparator. Therefore, it is possible to further shorten the non-operation period of the counter.

According to yet still another aspect of the present disclosure, [14] “in the radiation detector according to any one of [1] to [13], the plurality of pixel circuits may have a first pixel circuit region and a second pixel circuit region, and the first data may be stored in the first register at different timings in the first pixel circuit region and the second pixel circuit region”. According to the radiation detector described in [14], since the first data is held in the first register at different timings in the first pixel circuit region and the second pixel circuit region, it is possible to reduce a risk of crosstalk.

According to still yet another aspect of the present disclosure, [15] “the radiation detector according to [14] may further include: a power supply supplying a power supply voltage to each of the plurality of pixel circuits through a power transmission line; and a control unit configured to transmit a hold signal to each of the plurality of pixel circuits through a signal line, in which the second pixel circuit region may be arranged with the first pixel circuit region along a predetermined direction, and a direction in which the power transmission line is branched may intersect a direction in which the signal line is branched and the predetermined direction”. According to the radiation detector described in [15], since both the first pixel circuit region and the second pixel circuit region are present on each branched power transmission line, it is possible to further reduce the risk of the crosstalk.

According to yet still another aspect of the present disclosure, [16] there is provided “an integrated circuit including a plurality of pixel circuits each of which is provided corresponding to each of a plurality of pixels generating carriers in response to incident radiation, the plurality of pixels being arranged along a predetermined direction, each of the plurality of pixel circuits having at least one detection system configured to read out the carriers from a corresponding pixel of the plurality of pixels, in which the at least one detection system includes: a comparator comparing a first signal based on an amount of the carriers with a threshold value and outputting a second signal when the first signal exceeds the threshold value; a counter counting the number of second signals, each of which is the second signal; a first register holding first data which is a count value of the counter; a second register holding second data; an adder adding the first data and the second data to generate third data; and a third register holding the third data, and the second data is the third data transferred from the third register of a pixel circuit provided corresponding to a pixel adjacent to a corresponding pixel of the plurality of pixels in each of the plurality of pixel circuits”.

In the integrated circuit described in [16], the detection system of each of the plurality of pixel circuits includes the second register, the adder, and the third register. The second register holds, as the second data, the third data transferred from the third register in the pixel circuit provided corresponding to the pixel adjacent to the corresponding pixel. The adder adds the first data, which is the count value of the counter, and the second data to generate the third data. The third register holds the generated third data. This configuration makes it unnecessary to write (load) the count value in the pixel circuit in the previous stage to the counter of each pixel circuit. Therefore, it is possible to shorten the non-operation period of the counter. As a result, it is possible to increase the proportion of the operation period of the counter in each pixel circuit, that is, the period during which the radiation can be detected, to the entire operation period of the pixel circuit. In addition, when the first register is not provided, there is a problem in that it is not possible to update the count value until the count value is held in the register (for example, the third register) in the subsequent stage and the operation of the counter is stopped during that time. By provision of the first register, this problem does not occur. Therefore, it is possible to shorten the non-operation period of the counter. As described above, according to the integrated circuit described in [16], since the proportion of the period during which the radiation can be detected to the entire operation period is increased, it is possible to provide the integrated circuit with improved radiation detection efficiency.

According to still yet another aspect of the present disclosure, [17] there is provided “a radiation detection method including: generating carriers in response to incident radiation in a plurality of pixels arranged along a predetermined direction; reading out the carriers from a corresponding pixel of the plurality of pixels in a plurality of pixel circuits provided corresponding to the plurality of pixels, respectively; comparing a first signal based on an amount of the carriers with a threshold value and outputting a second signal when the first signal exceeds the threshold value; counting the number of second signals, each of which is the second signal; holding first data, which is a count value in the counting, in a first register; holding second data in a second register; adding the first data and the second data to generate third data; and holding the third data in a third register, in which the second data is the third data transferred from the third register of the pixel circuit provided corresponding to a pixel adjacent to a corresponding pixel of the plurality of pixels in each of the plurality of pixel circuits”.

The radiation detection method described in [17] includes the holding, as the second data, the third data transferred from the third register in the pixel circuit provided corresponding to the pixel adjacent to the corresponding pixel in the second register, the adding the first data, which is a count value in the counting, and the second data to generate the third data, and the holding the generated third data in the third register. Here, the counting is performed by a counter in each pixel circuit. This configuration makes it unnecessary to write (load) the count value in the pixel circuit in the previous stage to the counter of each pixel circuit. Therefore, it is possible to shorten the non-operation period of the counter. As a result, it is possible to increase the proportion of the operation period of the counter in each pixel circuit, that is, the period during which the radiation can be detected, to the entire operation period of the pixel circuit. In addition, when the first register is not provided, there is a problem in that it is not possible to update the count value until the count value is held in the register (for example, the third register) in the subsequent stage and the operation of the counter is stopped during that time. By provision of the first register, this problem does not occur. Therefore, it is possible to shorten the non-operation period of the counter. As described above, according to the radiation detection method described in [17], since the proportion of the period during which the radiation can be detected to the entire operation period is increased, it is possible to provide the radiation detection method with improved radiation detection efficiency.

### Advantageous Effects of Invention

According to an aspect of the present disclosure, it is possible to provide a radiation detector, an integrated circuit, and a radiation detection method with improved radiation detection efficiency.

### BRIEF DESCRIPTION OF DRAWINGS

FIG. 1 is a drawing illustrating a configuration of a radiation detector according to a first embodiment.

FIG. 2 is a plan view illustrating disposition of a plurality of pixel electrode portions on a rear surface of a conversion unit illustrated in FIG. 1.

FIG. 3 is a drawing illustrating a configuration of each pixel circuit illustrated in FIG. 1.

FIG. 4 is a circuit block diagram illustrating each pixel circuit illustrated in FIG. 1.

FIG. 5 is a drawing illustrating an example of charge sharing correction.

FIG. 6 is an example of a circuit diagram illustrating a counter illustrated in FIG. 4.

FIG. 7 is a circuit diagram illustrating the pixel circuit illustrated in FIG. 4.

FIG. 8 is a diagram illustrating a detailed configuration of the pixel circuit illustrated in FIG. 7.

FIG. 9 is a diagram illustrating a TDI operation in the pixel circuit illustrated in FIG. 7.

FIG. 10 is a diagram illustrating the TDI operation in the pixel circuit illustrated in FIG. 7.

FIG. 11 is a diagram illustrating the TDI operation in the pixel circuit illustrated in FIG. 7.

FIG. 12 is a diagram illustrating the TDI operation in the pixel circuit illustrated in FIG. 7.

FIG. 13 is an example of a circuit diagram illustrating an adder illustrated in FIG. 7.

FIG. 14 is an example of a circuit diagram illustrating each register illustrated in FIG. 7.

FIG. 15 is a drawing illustrating a radiation detection method using the radiation detector.

FIG. 16 is a diagram illustrating a detailed configuration of a pixel circuit of a pixel circuit according to a second embodiment.

FIG. 17 is an example of a circuit diagram illustrating a selector circuit illustrated in FIG. 16.

FIG. 18 is a diagram illustrating a configuration of input and output terminals of an adder illustrated in FIG. 16.

FIG. 19 is a diagram illustrating a TDI operation in a pixel circuit according to the second embodiment.

FIG. 20 is a diagram illustrating the TDI operation in the pixel circuit according to the second embodiment.

FIG. 21 is a diagram illustrating the TDI operation in the pixel circuit according to the second embodiment.

FIG. 22 is a circuit block diagram illustrating a pixel circuit according to a modification example.

FIG. 23 is a circuit diagram illustrating the pixel circuit illustrated in FIG. 22.

FIG. 24 is a circuit diagram illustrating the pixel circuit illustrated in FIG. 22.

FIG. 25 is a drawing illustrating a transfer direction of third data in the pixel circuit according to the modification example.

FIG. 26 is a diagram illustrating the transfer direction of the third data in the pixel circuit according to the modification example.

FIG. 27 is a diagram illustrating the transfer direction of the third data in the pixel circuit according to the modification example.

FIG. 28 is a diagram illustrating the transfer direction of the third data in the pixel circuit according to the modification example.

FIG. 29 is a diagram illustrating the transfer direction of the third data in the pixel circuit according to the modification example.

FIG. 30 is a diagram illustrating a detailed configuration of a pixel circuit of a pixel circuit according to a modification example.

FIG. 31 is a diagram illustrating a detailed configuration of a pixel circuit of a pixel circuit according to a modification example.

FIG. 32 is a drawing illustrating an example of a conversion unit, a power supply, and a control unit.

FIG. 33 (a) to (c) of FIG. 33 are drawings illustrating a first hold signal, a counter operation signal, and a counter reset signal.

FIG. 34 is a drawing illustrating an example of a plurality of pixel circuits divided into a first pixel circuit region and a second pixel circuit region.

FIG. 35 (a) to (d) of FIG. 35 are drawings illustrating the first hold signal and a second hold signal.

FIGS. 36 (a) and (b) of FIG. 36 are drawings illustrating an example of the first pixel circuit region and the second pixel circuit region.

FIGS. 37 (a) and (b) of FIG. 37 are drawings illustrating an example of the first pixel circuit region and the second pixel circuit region.

FIGS. 38 (a) and (b) of FIG. 38 are drawings illustrating an example of the first pixel circuit region and the second pixel circuit region.

FIG. 39 (a) to (e) of FIG. 39 are drawings illustrating the first hold signal, the second hold signal, and a third hold signal.

FIG. 40 is a drawing illustrating an example of the first pixel circuit region, the second pixel circuit region, and a third pixel circuit region.

### DESCRIPTION OF EMBODIMENTS

Hereinafter, embodiments of the present disclosure will be described in detail with reference to the drawings. In each drawing, the same or corresponding portions are denoted by the same reference numerals, and a duplicated description thereof will be omitted.

### First Embodiment

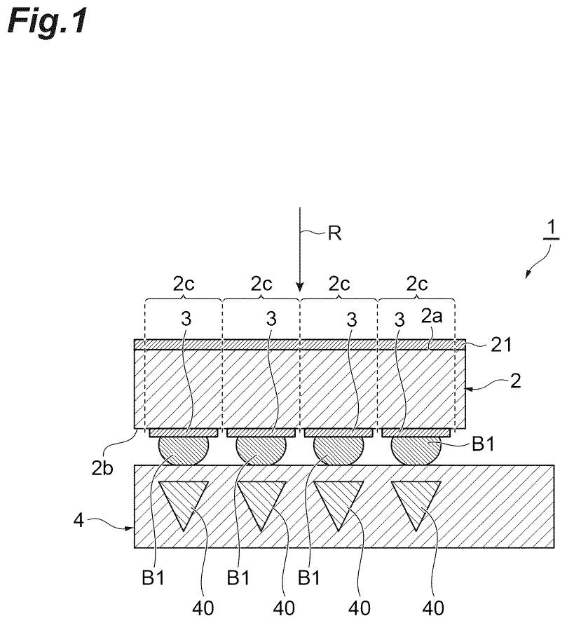

FIG. 1 is a drawing illustrating a configuration of a radiation detector 1 according to a first embodiment. As illustrated in FIG. 1, the radiation detector 1 includes a conversion unit 2, a plurality of pixel electrode portions 3, and an integrated circuit 4.

The conversion unit 2 is a bulk or layered member, absorbs radiation R, and generates carriers. The radiation R is, for example, an X-ray, a neutron ray, an alpha ray, a beta ray, a gamma ray, or the like. The conversion unit 2 is made of, for example, a material including at least one of CdTe, CdZnTe, GaAs, InP, TlBr, HgI₂, PbI₂, Si, Ge, and a-Se. The conversion unit 2 extends along a plane intersecting an incident direction of the radiation R. The conversion unit 2 has a front surface 2a and a rear surface 2b opposite to each other. For example, the front surface 2a is parallel to the rear surface 2b. When viewed from the incident direction of the radiation R, a planar shape of the conversion unit 2 is, for example, a rectangular shape or a square shape. The length of a long side of the conversion unit 2 when the planar shape of the conversion unit 2 is a rectangular shape or the length of one side of the conversion unit 2 when the planar shape of the conversion unit 2 is a square shape is, for example, within a range of 1 mm to 500 mm. A bias electrode 21 serving as a common electrode is provided on the front surface 2a so as to cover the entire front surface 2a. The radiation R transmitted through the bias electrode 21 is incident on the front surface 2a.

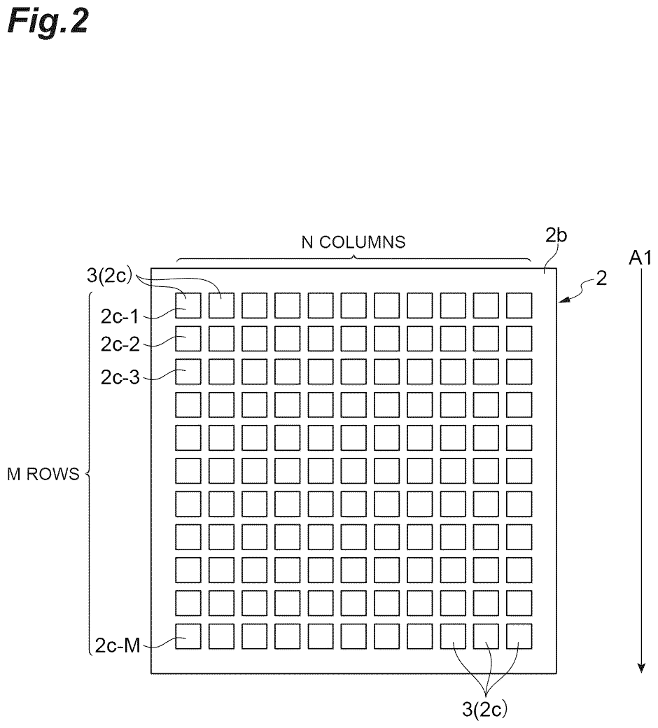

The plurality of pixel electrode portions 3 are conductive films provided on the rear surface 2b of the conversion unit 2. The pixel electrode portions 3 are, for example, metal films. A high bias voltage is applied between the pixel electrode portions 3 and the bias electrode 21 to deplete the conversion unit 2. FIG. 2 is a plan view illustrating the arrangement of the plurality of pixel electrode portions 3 on the rear surface 2b of the conversion unit 2. The plurality of pixel electrode portions 3 are arranged in a two-dimensional shape of M rows×N columns when viewed from the incident direction of radiation R. M and N are integers equal to or greater than 2. The two-dimensional shape is, for example, a matrix shape. The M×N pixel electrode portions 3 form pixels 2c in the M rows and the N columns in the conversion unit 2. In other words, a plurality of pixels 2c are arranged along row and column directions in the conversion unit 2. In the plurality of pixels 2c, carriers are generated in response to the incident radiation R. Each pixel electrode portion 3 collects the carriers generated in the corresponding pixel 2c. The radiation detector 1 performs a TDI operation of integrating the carriers generated in each pixel 2c for each column along a first direction A1 (predetermined direction) which is the column direction. In the example illustrated in FIG. 2, the radiation detector 1 integrates the carriers generated in a pixel 2c-1, a pixel 2c-2, a pixel 2c-3, . . . , a pixel 2c-M.

FIG. 1 is referred to again. The integrated circuit 4 has a plurality of pixel circuits (M×N pixel circuits) 40 connected to the plurality of pixel electrode portions 3, respectively. The integrated circuit 4 is implemented by, for example, an application specific integrated circuit (ASIC) or the like. Each of the plurality of pixel circuits 40 is electrically connected to a respective one of the plurality of pixel electrode portions 3 by bump bonding B1. The plurality of pixel circuits 40 are provided corresponding to the plurality of pixels 2c, respectively. Each pixel circuit 40 reads out the carriers from the corresponding pixel 2c. Specifically, each pixel circuit 40 detects the carriers collected in the corresponding pixel electrode portion 3. Each pixel circuit 40 counts the number of radiation hits on the basis of the detected carriers.

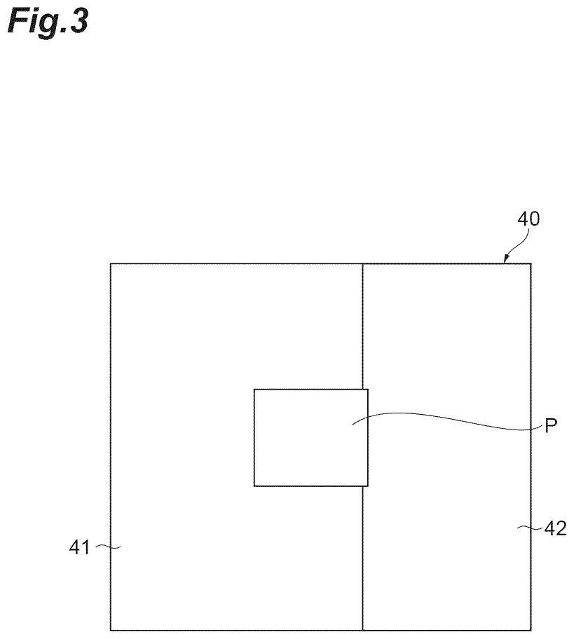

FIG. 3 is a drawing illustrating a configuration of each pixel circuit 40 illustrated in FIG. 1. When viewed from the incident direction of the radiation R, a planar shape of each pixel circuit 40 is, for example, a square shape. The length of one side is, for example, 50 μm to 250 μm. Each pixel circuit 40 includes a first region 41 occupied by an analog circuit and a second region 42 occupied by a digital circuit. The area of the first region 41 is larger than the area of the second region 42. The area of the first region 41 is equal to or larger than half of the entire area of each pixel circuit 40. A pad P is provided at the center of each pixel circuit 40 so as to face each pixel electrode portion 3. The pad P is electrically connected to each pixel electrode portion 3 by the bump bonding B1.

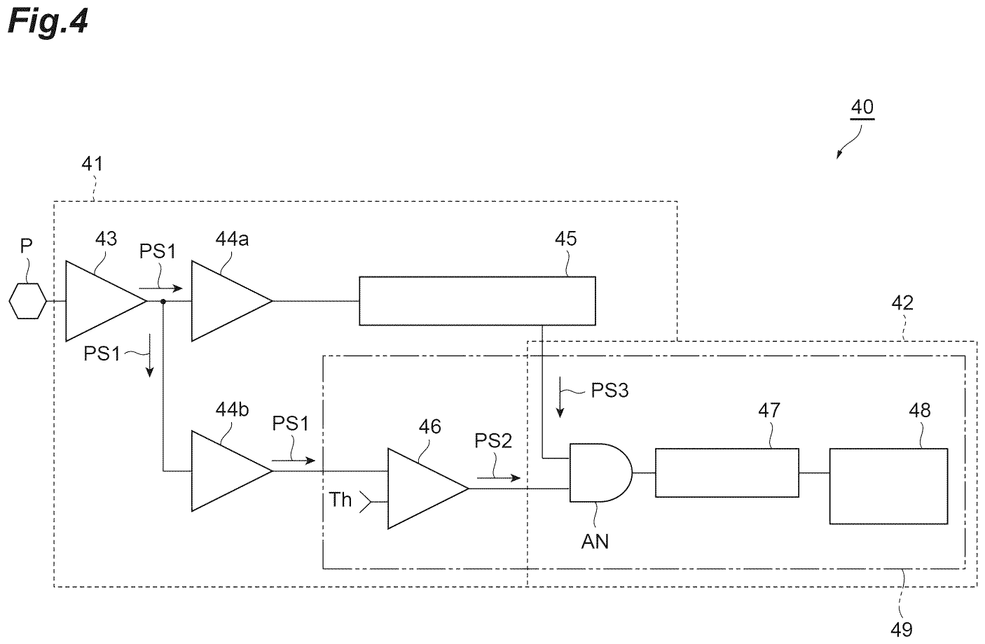

FIG. 4 is a circuit block diagram illustrating each pixel circuit 40 illustrated in FIG. 1. The first region 41 has an amplifier 43, shaper circuits 44a and 44b, a charge sharing countermeasure circuit 45, and a comparator 46. The second region 42 has a counter 47, a pixel circuit 48, and an AND circuit AN. Each pixel circuit 40 has one detection system 49. The one detection system 49 includes the comparator 46, the counter 47, the pixel circuit 48, and the AND circuit AN. The one detection system 49 reads out the carriers from the corresponding pixel 2c and counts the number of hits of the radiation R.

A wiring connection of a circuit block of each pixel circuit 40 will be described. An input terminal of the amplifier 43 is connected to the pad P. An output terminal of the amplifier 43 is connected to an input terminal of the shaper circuit 44a and an input terminal of the shaper circuit 44b respectively. An output terminal of the shaper circuit 44a is connected to the charge sharing countermeasure circuit 45. The charge sharing countermeasure circuit 45 is connected to one of input terminals of the AND circuit AN. An output terminal of the shaper circuit 44b is connected to an inverting input terminal or a non-inverting input terminal of the comparator 46. An output terminal of the comparator 46 is connected to the other input terminal of the AND circuit AN. An output terminal of the AND circuit AN is connected to an input terminal of the counter 47. An output terminal of the counter 47 is connected to the pixel circuit 48.

The amplifier 43 outputs a first pulse signal PS1 (first signal) corresponding to the amount of carriers collected in each pixel electrode portion 3. The first pulse signal PS1 is, for example, a voltage pulse and has a voltage value proportional to the amount of carriers. The first pulse signal PS1 has a predetermined time constant and requires a certain rise time to reach the voltage value proportional to the amount of carriers. The rise time is equal to or less than several tens of nanoseconds and is, for example, 10 ns. The shaper circuits 44a and 44b remove high-frequency components and low-frequency components from the first pulse signal PS1. When the time constant of the first pulse signal PS1 is reduced, the fall time of the first pulse signal PS1 is shortened.

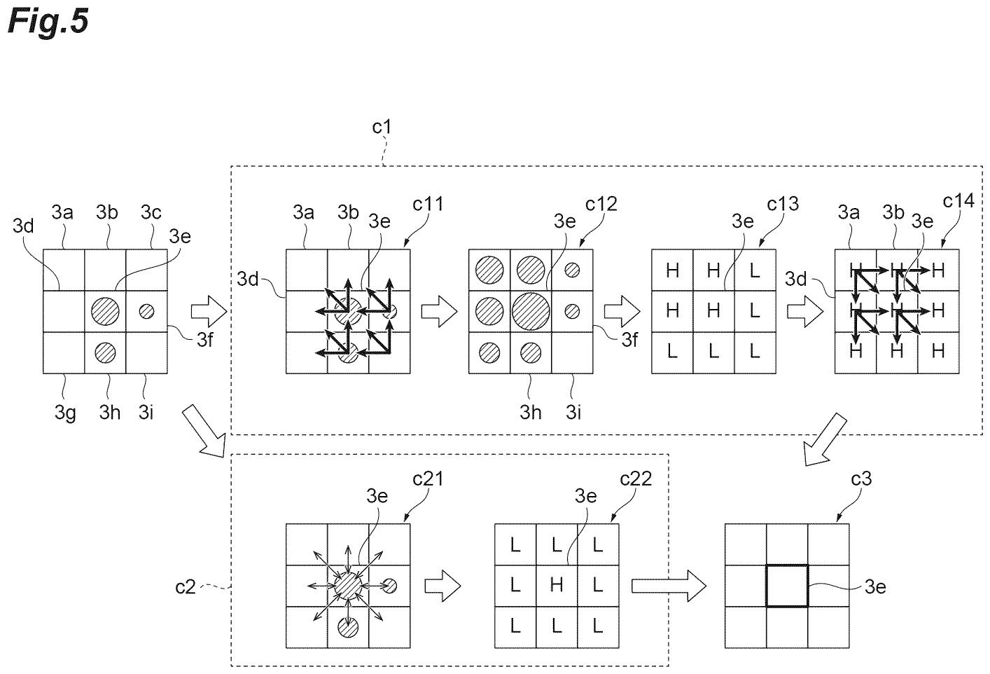

The shaper circuit 44b, the charge sharing countermeasure circuit 45, and the comparator 46 perform charge sharing correction. FIG. 5 is a drawing illustrating an outline of the charge sharing correction. FIG. 5 illustrates a pixel electrode portion 3e corresponding to the pixel circuit 40, to which the pixel electrode portion 3e belongs, and eight pixel electrode portions 3a, 3b, 3c, 3d, 3f, 3g, 3h, and 3i surrounding the pixel electrode portion 3e. The charge sharing correction includes energy correction c1 and position correction c2.

The energy correction c1 will be described on the basis of the pixel electrode portion 3e. First, a copy circuit (not illustrated) provided in a stage following the amplifier 43 copies the first pulse signal PS1 to the pixels (pixel electrode portions 3a, 3b, and 3d) adjacent to the pixel electrode portion 3e (copy process c11). Then, the shaper circuit 44b adds the first pulse signals PS1 corresponding to four pixels obtained by combining copy signals from the adjacent pixels (pixel electrode portions 3f, 3h, and 3i) and the pixel electrode portion 3e to generate a corrected first pulse signal PS1 (summing process c12). As a result, the shaper circuit 44b adds the sum of the amounts of carriers collected in three pixel electrode portions 3f, 3h, and 3i adjacent to the pixel electrode portion 3e to the amount of carriers collected in the pixel electrode portion 3e corresponding to the pixel circuit 40, to which the shaper circuit 44b belongs, to correct the amount of carriers. The number of pixel electrode portions for which the amounts of carriers are to be added in the shaper circuit 44b is not limited to three. For example, the shaper circuit 44b may add the sum of the amounts of carriers collected in eight pixel electrode portions 3a, 3b, 3c, 3d, 3f, 3g, 3h, and 3i adjacent to the pixel electrode portion 3e to the amount of carriers collected in the pixel electrode portion 3e corresponding to the pixel circuit 40, to which the shaper circuit 44b belongs, to correct the amount of carriers. Alternatively, the shaper circuit 44b may add the sum of the amounts of carriers collected in two pixel electrode portions (for example, the pixel electrode portions 3f and 3h) to the amount of carriers collected in the pixel electrode portion 3e corresponding to the pixel circuit 40, to which the shaper circuit 44b belongs, to correct the amount of carriers.

Then, the comparator 46 compares the corrected first pulse signal PS1 with a threshold value Th to discriminate the corrected first pulse signal PS1 (discrimination process c13). The corrected first pulse signal PS1 from the shaper circuit 44b is input to one of the inverting input terminal and the non-inverting input terminal of the comparator 46, and the threshold value Th is input to the other terminal. The comparator 46 compares the corrected first pulse signal PS1 with the threshold value Th. Specifically, when the value of the corrected first pulse signal PS1 is larger than the threshold value Th, the comparator 46 outputs a second pulse signal PS2 (second signal). The second pulse signal PS2 is, for example, a high-level voltage signal. This corresponds to “H” in the discrimination process c13 in FIG. 5. When the value of the first pulse signal PS1 is smaller than the threshold value Th, the comparator 46 does not output the second pulse signal PS2. This corresponds to “L” in the discrimination process c13 in FIG. 5. One output of the second pulse signal PS2 can be reworded as one hit of radiation. Then, an OR circuit (not illustrated) provided in a stage preceding the counter 47 calculates the logical sum of the second pulse signal PS2 of the pixel electrode portion 3e and the second pulse signals PS2 of the pixels (pixel electrode portions 3a, 3b, and 3d) adjacent to the pixel electrode portion 3e (OR process c14). This OR process c14 is performed to eliminate ambiguity caused by a combination of a charge sharing pattern and an addition set at the time of the summing process c12.

The position correction c2 will be described on the basis of the pixel electrode portion 3e. When the carriers generated by the incidence of the radiation R are distributed and collected in two or more pixel electrode portions 3, the charge sharing countermeasure circuit 45 determines that the pixel electrode portion 3 in which the largest number of carriers have been collected is the pixel electrode portion 3 corresponding to the position where the radiation R is incident. Specifically, the charge sharing countermeasure circuit 45 copies the first pulse signal PS1 output from the shaper circuit 44a to adjacent pixels (pixel electrode portions 3a, 3b, 3c, 3d, 3f, 3g, 3h, and 3i). At the same time, the charge sharing countermeasure circuit 45 compares the copied signals received from the adjacent pixels (pixel electrode portions 3a, 3b, 3c, 3d, 3f, 3g, 3h, and 3i) with the first pulse signal PS1 of the pixel electrode portion 3e (comparison process c21). Then, the charge sharing countermeasure circuit 45 determines whether or not the pixel electrode portion 3e corresponding to the pixel circuit 40, to which the charge sharing countermeasure circuit 45 belongs, is the pixel electrode portion 3 corresponding to the position where the radiation R is incident. Specifically, the charge sharing countermeasure circuit 45 determines whether or not the magnitude of the first pulse signal PS1 of the pixel electrode portion 3e is greater than those of all of the adjacent pixels (election process c22). When it is determined that the magnitude of the first pulse signal PS1 of the pixel electrode portion 3e is greater than the first pulse signals PS1 of all of the adjacent pixels, a third pulse signal PS3, which is an output signal from the charge sharing countermeasure circuit 45 of the pixel electrode portion 3e, becomes “H”. The charge sharing countermeasure circuit 45 can be implemented by, for example, an electronic circuit including a logic circuit.

After the energy correction c1 and the position correction c2, the AND circuit AN provided in the stage preceding the counter 47 calculates the logical conjunction of the second pulse signal PS2 subjected to the OR process and the third pulse signal PS3 output from the charge sharing countermeasure circuit 45. When the third pulse signal PS3 is “H”, the second pulse signal PS2 of the pixel electrode portion 3e is active (AND process c3) and is transmitted to the counter 47 in the subsequent stage. In other words, in the election process c22, when the charge sharing countermeasure circuit 45 determines that the pixel electrode portion 3e corresponding to the pixel circuit 40, to which the charge sharing countermeasure circuit 45 belongs, is the pixel electrode portion 3 corresponding to the position where the radiation R is incident, the charge sharing countermeasure circuit 45 enables the output of the comparator 46. On the other hand, when determining that the pixel electrode portion 3e corresponding to the pixel circuit 40, to which the charge sharing countermeasure circuit 45 belongs, is not the pixel electrode portion 3 corresponding to the position where the radiation R is incident, the charge sharing countermeasure circuit 45 disables the output of the comparator 46. The charge sharing countermeasure circuit 45 and the addition operation of the shaper circuit 44b can be omitted from the pixel circuit 40. In this case, the uncorrected first pulse signal PS1 is input from the shaper circuit 44b to one of the inverting input terminal and the non-inverting input terminal of the comparator 46.

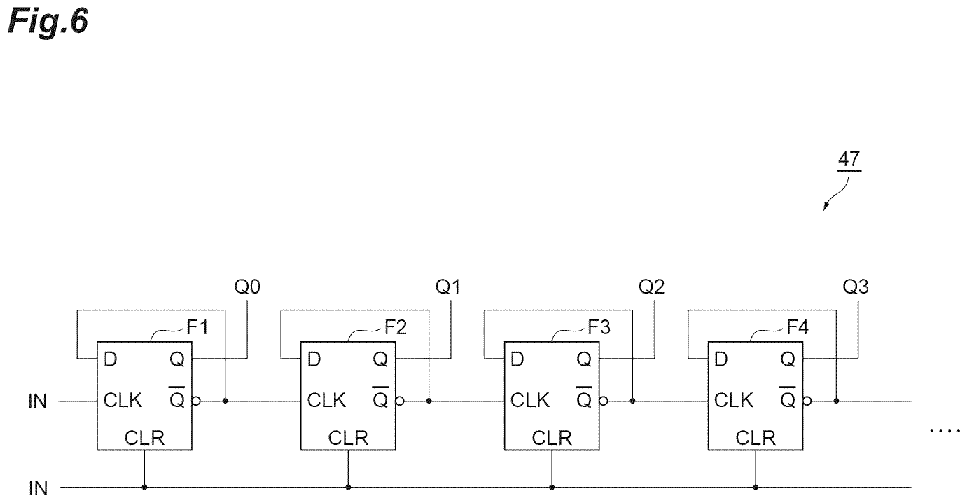

The counter 47 counts the number of second pulse signals PS2 output. In other words, the counter 47 counts the number of radiation hits. The counted value is output to the pixel circuit 48. The counter 47 is, for example, a 4-bit up-counter or down-counter and is configured using four stages of flip-flops F1 to F4 in the example illustrated in FIG. 6. When the counter 47 is an up-counter, an output (/Q) of the flip-flop F1 in the first stage is connected to an input (CLK) of the flip-flop in the second stage. Similarly, an output (/Q) of the flip-flop F2 in the second stage is connected to an input (CLK) of the flip-flop F3 in the third stage. The same applies to the flip-flop F3 in the third stage and the flip-flop F4 in the fourth stage. The output (/Q) of the flip-flop F1 in the first stage is switched at the fall timing of CLK. The output (/Q) of the flip-flop F2 in the second stage is switched at the fall timing of Q0. The output (/Q) of the flip-flop F3 in the third stage is switched at the fall timing of Q1. The output (/Q) of the flip-flop F4 in the fourth stage is switched at the fall timing of Q2.

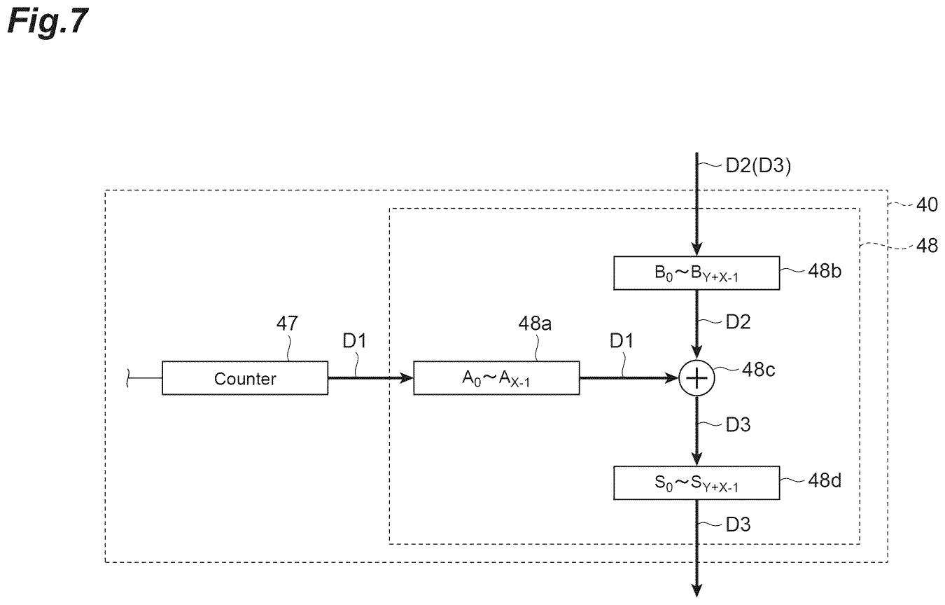

FIG. 7 is a circuit diagram illustrating the pixel circuit 48 illustrated in FIG. 4. The pixel circuit 48 has a first register 48a, a second register 48b, an adder 48c, and a third register 48d. The first register 48a holds first data D1 which is the count value output from the counter 47. The first data D1 indicates the number of second pulse signals PS2 counted by the counter 47. The wiring between the counter 47 and the first register 48a is, for example, parallel wiring including the same number of wiring lines as the number of bits of the maximum count value of the counter 47. In this case, the first register 48a simultaneously holds the first data D1 for all bits at any timing. The wiring between the counter 47 and the first register 48a may be serial wiring.

The second register 48b holds second data D2. The adder 48c adds the first data D1 and the second data D2 to generate third data D3. The third register 48d holds the generated third data D3. As a specific means for integrating the carriers along the first direction A1 (predetermined direction) illustrated in FIG. 2 in a plurality of pixels 2c, a plurality of pixel circuits 40 transfer the third data D3 between the pixel circuits 40 corresponding to the pixels 2c. That is, the TDI operation of integrating the carriers generated in each pixel 2c along the first direction A1 is performed by the transfer of the third data D3 by each pixel circuit 40 corresponding to each pixel 2c. The description will be made referring again to FIG. 2. The pixel circuit 40 corresponding to the pixel 2c-1 transfers the third data D3 to the pixel circuit 40 corresponding to the pixel 2c-2 adjacent to the pixel 2c-1. Then, the pixel circuit 40 corresponding to the pixel 2c-2 holds the transferred third data D3 as the second data D2. Then, the pixel circuit 40 corresponding to the pixel 2c-2 adds the first data D1 held in the first register 48a of the pixel circuit 40 corresponding to the pixel 2c-2 to the second data D2. Then, the pixel circuit 40 corresponding to the pixel 2c-2 holds the added value as the third data D3 and transfers the third data D3 to the pixel circuit 40 corresponding to the pixel 2c-3 adjacent to the pixel 2c-2. This operation is repeated up to the pixel circuit 40 corresponding to the pixel 2c-M in the last row. Here, the second data D2 is the third data D3 transferred from the third register 48d of the pixel circuit 40 provided corresponding to one pixel 2c (the pixel 2c-1 when viewed from the pixel 2c-2 in FIG. 2) adjacent to the corresponding pixel 2c in the first direction A1 in each of the plurality of pixel circuits 40.

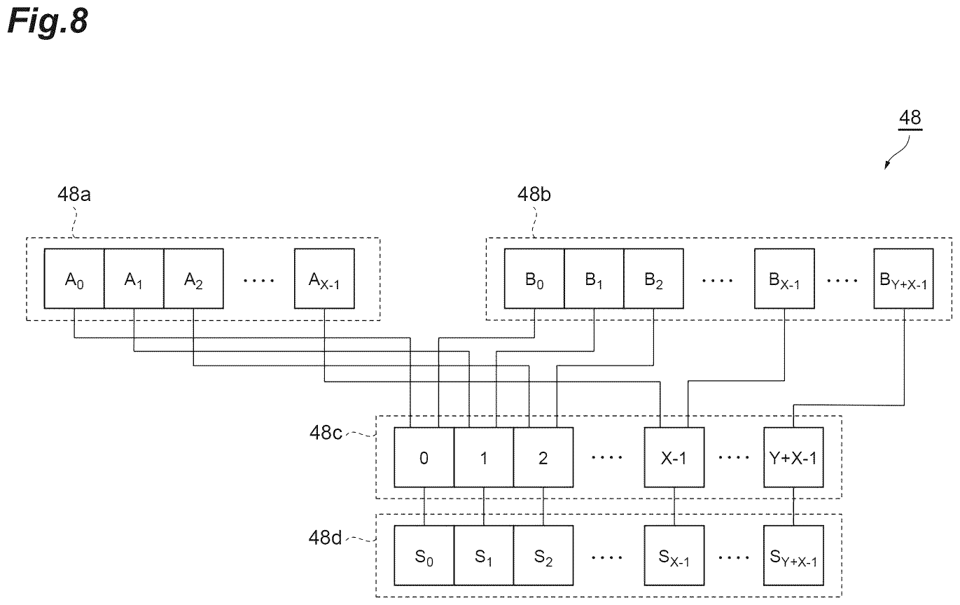

FIG. 8 is a diagram illustrating a detailed configuration of the pixel circuit 48 illustrated in FIG. 7. A₀ to A_{X-1} indicate bits of the first register 48a. The number of bits of the first register 48a is X which is the maximum count value of the counter 47. B₀ to B_{Y+X-1} indicate bits of the second register 48b. S₀ to S_{Y+X-1} indicate the bits of the third register 48d. The numbers of bits of the second register 48b and the third register 48d are X+Y bits. Here, Y is a binary representation of M which is the number of rows of the plurality of pixel circuits 40. For example, when the number of rows of M is 64, Y is 6. The bits X+Y is the maximum number of bits required to add the first data D1 of each pixel circuit 40 to the third data D3 (the second data D2 in each pixel circuit 40) transferred from the third register 48d. The number of bits of the adder 48c is X+Y which is equal to the numbers of bits of the second register 48b and the third register 48d. In this embodiment, the adder 48c performs an addition process for each bit in parallel. For example, the adder 48c adds the least significant bit A₀ of the first register 48a and the least significant bit B₀ of the second register 48b at the least significant bit 0 of the adder 40c and holds the added value in the least significant bit S₀ of the third register 48d. The adder 40c performs this addition process for all bits (the least significant bit 0 to the most significant bit Y+X−1) in parallel.

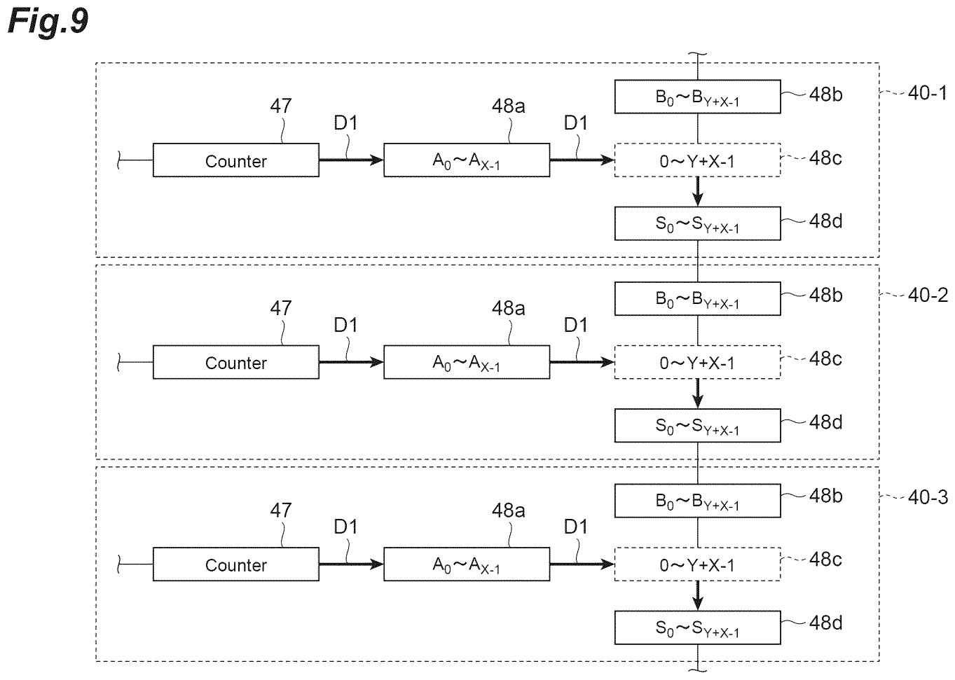

FIGS. 9 to 12 are diagrams illustrating the TDI operation of the pixel circuit 40 illustrated in FIG. 7. Since the adder 48c performs the addition process for the first bit to the (X+Y)-th bit in parallel, the adder 48c is represented as 0 to Y+X−1 in FIGS. 9 to 12. In FIGS. 9 to 12, among the plurality of pixel circuits 40, a pixel circuit 40-1, a pixel circuit 40-2, and a pixel circuit 40-3 are arranged in the column direction. The third data D3 of the pixel circuit 40-1 is transferred to the pixel circuit 40-2, and the third data D3 of the pixel circuit 40-2 is transferred to the pixel circuit 40-3. The timings when the registers 48a, 48b, and 48d in each of the pixel circuits 40 hold the data items D1, D2, and D3, respectively, can be set arbitrarily. When each of the data items D1, D2, and D3 is held, the outputs of the registers 48a, 48b, and 48d are updated to the data items D1, D2, and D3, respectively.

The operation of each pixel circuit 40 will be described. This operation is performed in the pixel circuit 40-1, the pixel circuit 40-2, and the pixel circuit 40-3 at the same time. First, as illustrated in FIG. 9, the first register 48a of each pixel circuit 40 holds the first data D1 and outputs the first data D1 to the adder 48c. At this time, the second register 48b does not hold the second data D2. The output of the adder 48c is automatically updated when the first data D1 is input. Therefore, in this stage, an invalid value is output from the adder 48c.

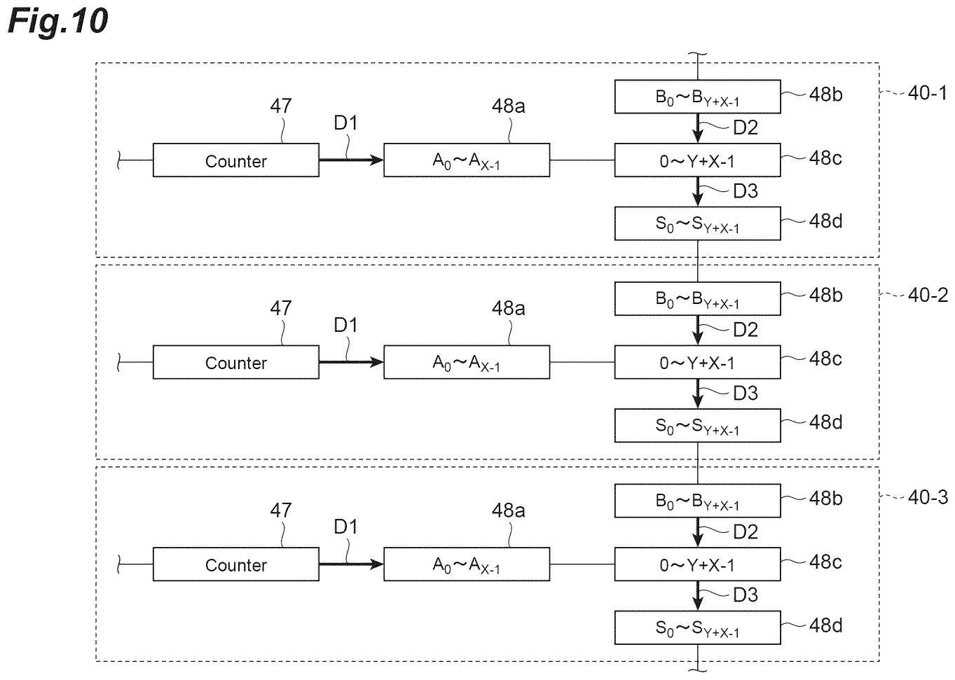

Then, as illustrated in FIG. 10, the second register 48b holds the third data D3 transferred from the pixel circuit 40 in the previous row (for example, the pixel circuit 40-1 when viewed from the pixel circuit 40-2) as the second data D2 and outputs the second data D2 to the adder 48c. The adder 48c outputs the third data D3 obtained by adding the first data D1 and the second data D2. At this time, the third register 48d does not yet hold the third data D3. The holding of the second data D2 by the second register 48b may be performed before the holding of the first data D1 by the first register 48a.

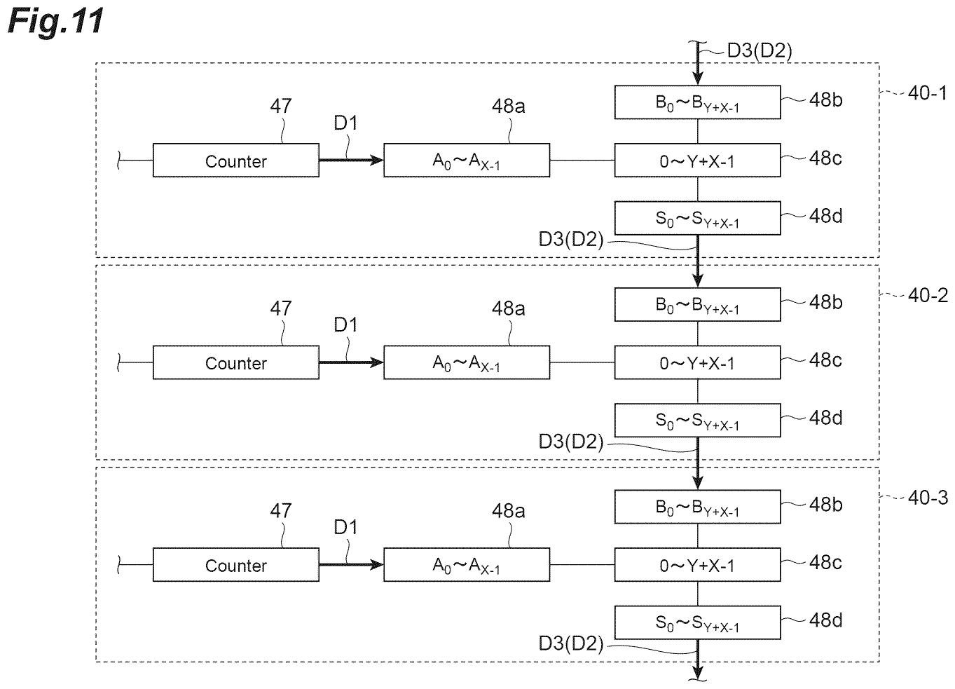

Then, as illustrated in FIG. 11, the third register 48d holds the third data D3 and outputs the third data D3 to the pixel circuit 40 in the next row (for example, the pixel circuit 40-3 when viewed from the pixel circuit 40-2).

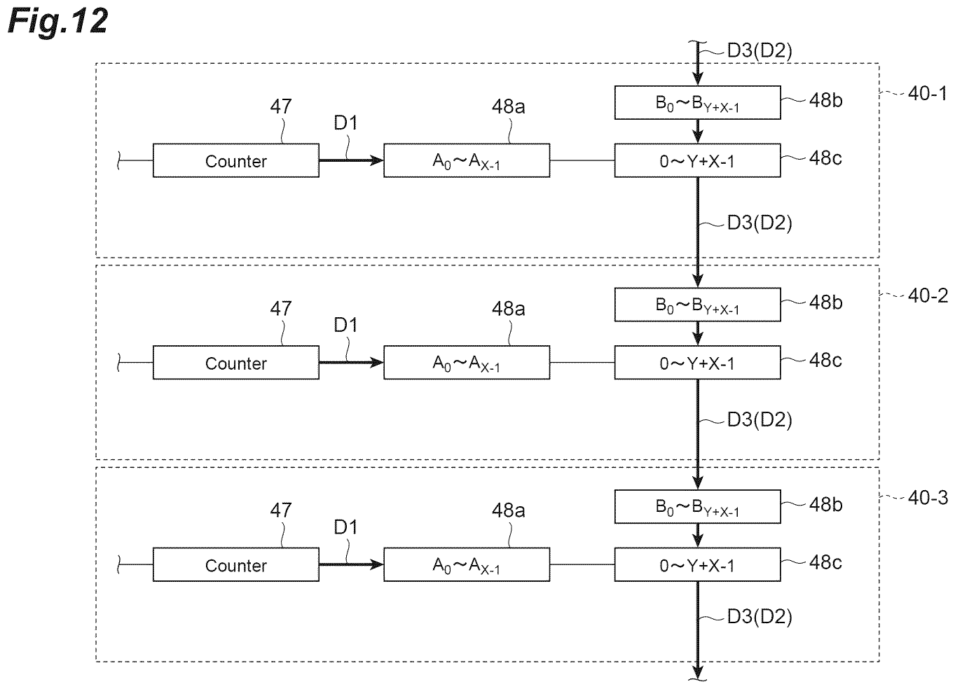

Here, if the first register 48a is absent, the counter 47 needs to be stopped until the first data D1 is added to the second data D2 by the adder 48c and the third data D3 is held in the third register. Therefore, the first register 48a is provided in order to extend the counting operation period of the counter 47. As illustrated in FIG. 12, in a case where the third register 48d is absent, when the second register 48b holds the second data D2, the second data D2 continues to be output as the third data D3 to the pixel circuits 40 in all of the subsequent rows. In this case, it is difficult to add the first data D1 at an appropriate timing according to the above-mentioned procedure. In other words, the output of the adder 48c changes at the timing when the second register 48b holds the second data D2. As a result, it is not possible to simultaneously perform the operation of transferring the value counted by counter 47 to the pixel circuit 40 in the subsequent row in all of the pixel circuits 40, which makes it difficult to perform the TDI operation. The same applies when the second register 48b is absent. Therefore, the second register 48b and the third register 48d are provided in order to appropriately perform the TDI operation.

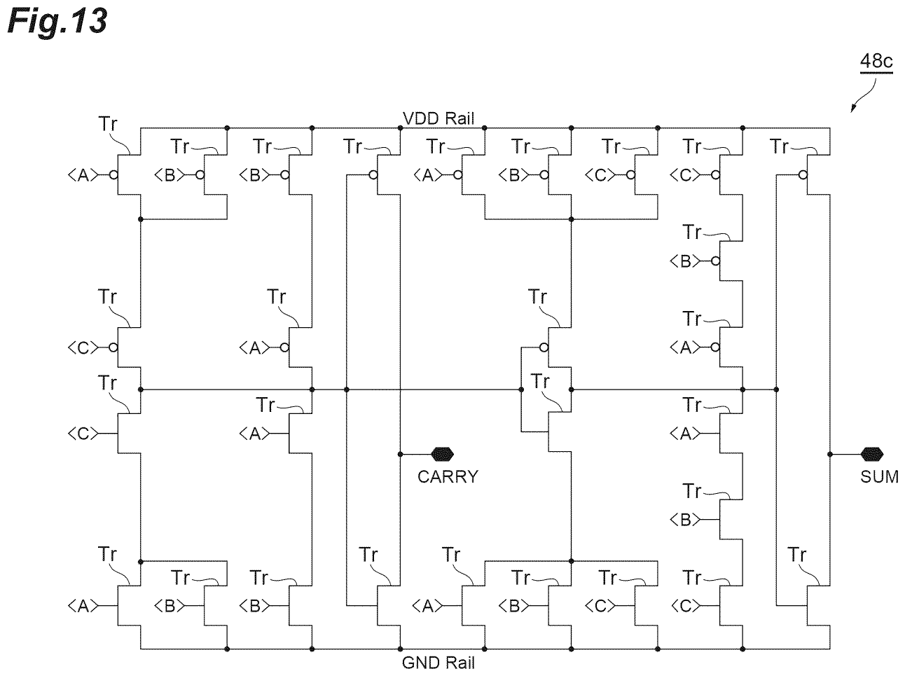

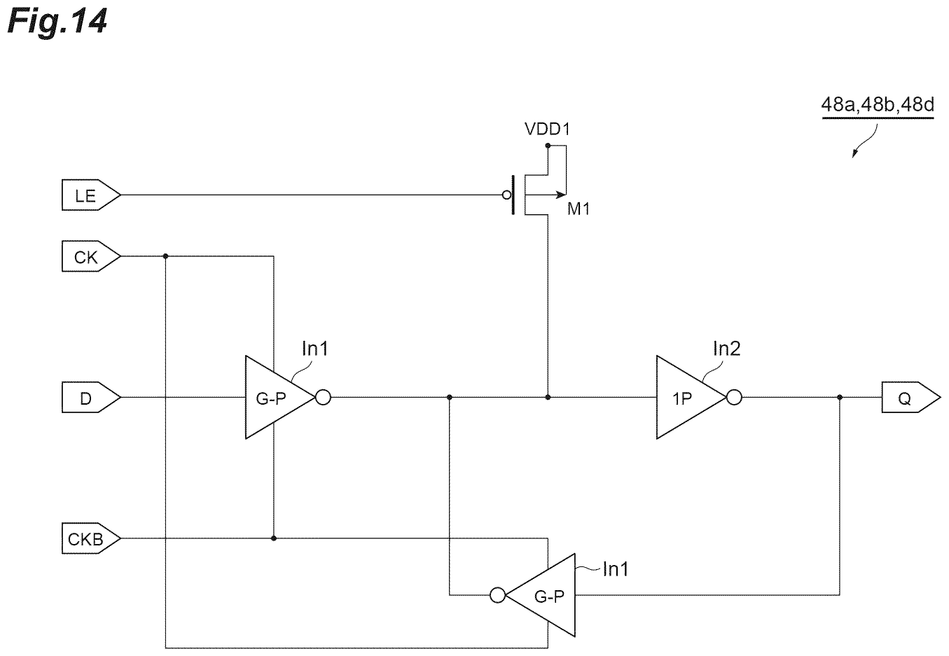

FIG. 13 is an example of a circuit diagram illustrating the adder 48c illustrated in FIG. 7. The adder 48c is a full adder that receives three input signals A, B, and C and performs binary addition. The adder 48c is a composite logic circuit composed of 28 transistors Tr. An addition result SUM and a carry signal CARRY to a high-order digit are obtained as output signals. FIG. 14 is an example of a circuit diagram illustrating each of the registers 48a, 48b, and 48d illustrated in FIG. 7. Each of the registers 48a, 48b, and 48d is a D-latch circuit including a clocked inverter In1 and an inverter In2. Each of the registers 48a, 48b, and 48d requires a total of 11 transistors. The input and output of each of the registers 48a, 48b, and 48d are configured by an input signal (D), a latch enable signal (LE), and an output (Q). When the latch enable signal (LE) is at a low level, the previous output (Q) is held. When the latch enable signal (LE) is at a high level, the same logic as an input logic is output.

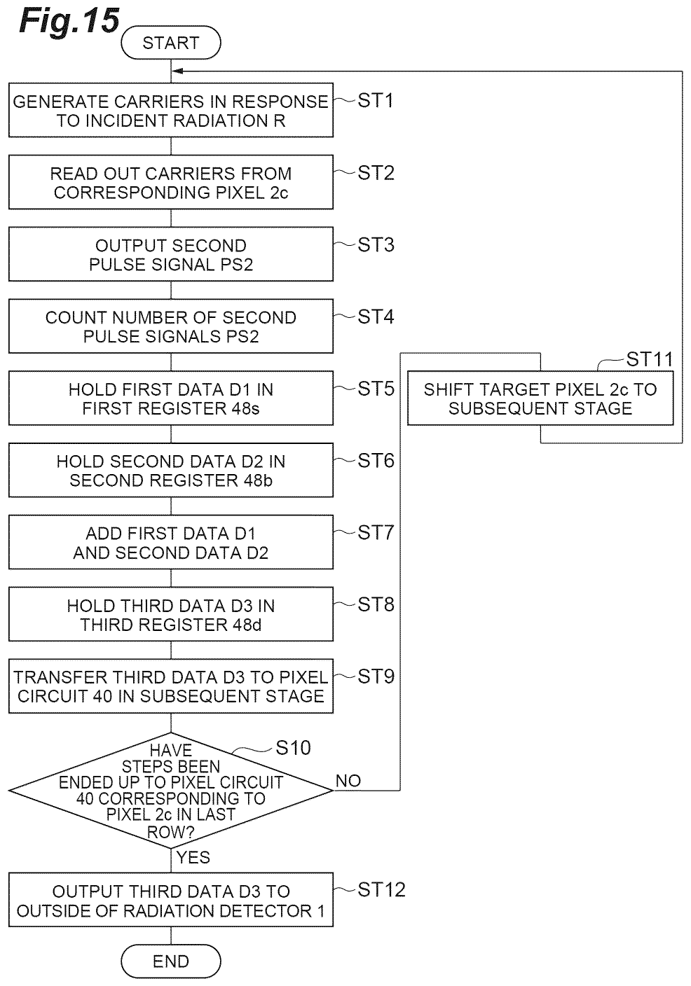

FIG. 15 is a drawing illustrating a radiation detection method using the radiation detector 1. The radiation detection method includes steps ST1 to ST12. In step ST1, carriers are generated in response to the incident radiation R in a plurality of pixels 2c arranged along the first direction A1. Then, in step ST2, a plurality of pixel circuits 40 provided corresponding to the plurality of pixels 2c, respectively, read out the carriers from the corresponding pixels 2c. Then, in step ST3, the first pulse signal PS1 based on the amount of carriers is compared with the threshold value Th. When the first pulse signal PS1 exceeds the threshold value Th, the second pulse signal PS2 is output. Step ST3 is performed by the comparator 46. Then, in step ST4, the number of second pulse signals PS2 is counted. Step ST4 is performed by the counter 47. Then, in step ST5, the first data D1, which is the count value of the counter 47, is held in the first register 48a. Then, in step ST6, the second data D2 is held in the second register 48b. Step ST6 may be performed prior to step ST5. Then, in step ST7, the first data D1 and the second data D2 are added together. In step ST7, the first data D1 and the second data D2 are added together to generate the third data D3. Step ST7 is performed by the adder 48c. Then, in step ST8, the third data D3 is held in the third register 48d. Here, the second data D2 is the third data D3 transferred from the third register 48d of the pixel circuit 40 provided corresponding to the pixel 2c adjacent to the corresponding pixel 2c in each of the plurality of pixel circuits 40. Then, in step ST9, the third data D3 is transferred to the pixel circuit 40 in the subsequent stage. Then, in step ST10, it is determined whether or not steps ST1 to ST9 have been ended up to the pixel circuit 40 corresponding to the pixel 2c in the last row. When steps ST1 to ST9 have not been ended up to the pixel circuit 40 corresponding to the pixel 2c in the last row (step ST10; NO), the target pixel 2c is shifted to the subsequent next stage (step ST11), and steps ST1 to ST9 are performed again. On the other hand, when steps ST1 to ST9 have been ended up to the pixel circuit 40 corresponding to the pixel 2c in the last row (step ST10; YES), the third data D3 is output to the outside of the radiation detector 1 in step ST12. With the end of step ST12, the series of steps in the radiation detection method ends.

### [Operation and Effect]

In the radiation detector 1 and the integrated circuit 4, the detection system 49 of each of the plurality of pixel circuits 40 has the second register 48b, the adder 48c, and the third register 48d. The second register 48b holds, as the second data D2, the third data D3 transferred from the third register 48d in the pixel circuit 40 provided corresponding to the pixel 2c adjacent to the corresponding pixel 2c. The adder 48c adds the first data D1, which is the count value of the counter 47, and the second data D2 to generate the third data D3. The third register 48d holds the generated third data D3. This configuration makes it unnecessary to write (load) the count value in the pixel circuit 40 in the previous stage to the counter 47 of each pixel circuit 40. Therefore, it is possible to shorten the non-operation period of the counter 47. As a result, it is possible to increase the proportion of the operation period of the counter 47 in each pixel circuit 40, that is, the period during which the radiation R can be detected, to the entire operation period of the pixel circuit 40. In addition, when the first register 48a is not provided, there is a problem in that it is not possible to update the count value until the count value is held in the register (for example, the third register 48d) in the subsequent stage and the operation of the counter 47 is stopped during that time. By provision of the first register 48a, this problem does not occur. Therefore, it is possible to further shorten the non-operation period of the counter 47. As described above, according to the radiation detector 1, since the proportion of the period during which the radiation R can be detected to the entire operation period is increased, it is possible to provide the radiation detector 1 and the integrated circuit 4 with improved detection efficiency of the radiation R.

In each of the plurality of the pixel circuits 40 in the radiation detector 1, the area of the first region 41 occupied by the analog circuit including the comparator 46 is larger than the area of the second region 42 occupied by the digital circuit including the counter 47, the first register 48a, the second register 48b, the adder 48c, and the third register 48d. In the first region 41, at least one of the size of the element and a mounting interval between the elements may be changed in order to suppress a variation in characteristics of each element. According to the radiation detector 1, since the area of the first region 41 is large, it is possible to improve flexibility in the design of the analog circuit. In addition, it is possible to relatively simply configure the function of transferring the third data D3 between the pixel circuits 40 (the TDI function of the digital circuit). Therefore, it is possible to reduce the area of the digital circuit.

In the radiation detector 1, the area of the first region 41 is equal to or larger than half of the total area of each of the plurality of pixel circuits 40. Therefore, since the area of the first region 41 is large, it is possible to improve flexibility in the design of the analog circuit.

In the radiation detector 1, the number of bits of the second register 48b is the sum X+Y of the number of bits X of the first register 48a and the number of bits Y which is the binary representation of the number of pixel circuits 40, and the number of bits of the adder 48c is equal to the number of bits X+Y of the second register 48b. According to this configuration, since the number of bits X+Y of the adder 48c is equal to the number of bits X+Y of the second register 48b, it is possible to perform the addition process for each bit in parallel. Therefore, it is possible to improve the processing speed.

In the radiation detector 1, each of the plurality of pixel circuits 40 further includes the charge sharing countermeasure circuit 45 that, when the carriers generated by the incidence of the radiation R are dispersively read out to two or more pixel circuits 40, determines the pixel 2c corresponding to the position where the radiation R is incident and corrects and evaluates the amount of carriers in the pixel 2c, or ignores the incidence of the radiation R. This makes it possible to suppress the deterioration of energy resolution and the blurring of images caused by charge sharing.

In the radiation detector 1, each of the plurality of pixel circuits 40 further includes the shaper circuits 44a and 44b provided in the stage preceding the comparator 46, and the shaper circuits 44a and 44b reduce the time constant of the first pulse signal PS1. This makes it possible for the shaper circuits 44a and 44b to increase the response speed of the comparator 46, which makes it possible to further shorten the non-operation period of the counter 47.

The radiation detection method using the radiation detector 1 includes step ST6 of holding in the second register 48b, as the second data D2, the third data D3 transferred from the third register 48d in the pixel circuit 40 provided corresponding to the pixel 2c adjacent to the corresponding pixel 2c, step ST7 of adding the first data, which is the count value in Counting step ST4, and the second data to generate the third data, and step ST8 of holding the generated third data D3 in the third register 48d. Here, Counting step ST4 is performed by the counter 47 of each pixel circuit 40. This configuration makes it unnecessary to write (load) the count value from the pixel circuit 40 in the previous stage to the counter 47 of each pixel circuit 40. Therefore, it is possible to shorten the non-operation period of the counter 47. As a result, it is possible to increase the proportion of the operation period of the counter 47 in each pixel circuit 40, that is, the period during which the radiation R can be detected, to the entire operation period of the pixel circuit 40. In addition, when the first register 48a is not provided, there is a problem in that it is not possible to update the count value until the count value is held in the register (for example, the third register 48d) in the subsequent stage and the operation of the counter 47 is stopped during that time. By provision of the first register 48a, this problem does not occur. Therefore, it is possible to shorten the non-operation period of the counter 47. As described above, according to the radiation detection method using the radiation detector 1, since the proportion of the period during which the radiation R can be detected to the entire operation period is increased, it is possible to provide the radiation detection method with improved radiation detection efficiency.

### Second Embodiment

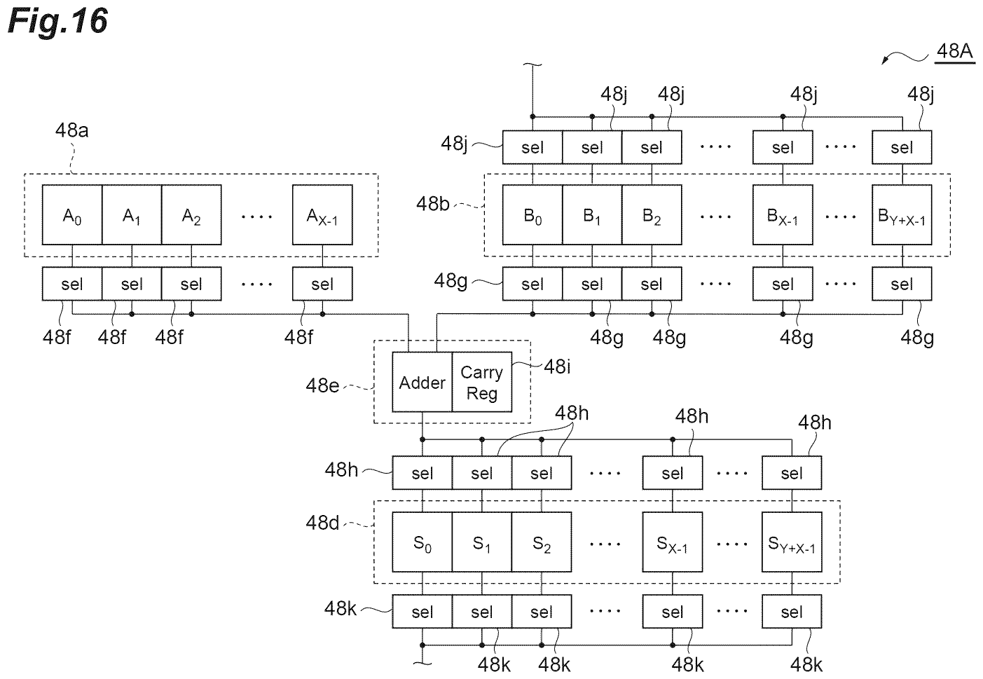

FIG. 16 is a diagram illustrating a detailed configuration of a pixel circuit 48A of a pixel circuit 40 according to a second embodiment. Only differences from the first embodiment will be described. The pixel circuit 48A has an adder 48e instead of the adder 48c according to the first embodiment. The number of bits of the adder 48e is smaller than the number of bits Y of the second register 48b and is one bit in this embodiment. The adder 48e includes a fourth register 48i for holding the carry signal. The pixel circuit 48A has a plurality of first selector circuits 48f, a plurality of second selector circuits 48g, a plurality of third selector circuits 48h, a plurality of fourth selector circuits 48k, and a plurality of fifth selector circuits 48j. Each of the plurality of first selector circuits 48f corresponds to each of X bits of the first register 48a. Each of the plurality of second selector circuits 48g and each of the plurality of fifth selector circuits 48j correspond to each of X+Y bits of the second register 48b. Each of the plurality of third selector circuits 48h and each of the plurality of fourth selector circuits 48k correspond to each of X+Y bits of the third register 48d. The plurality of fourth selector circuits 48k are serially connected to the plurality of fifth selector circuits 48j of the pixel circuit 40 in the subsequent row.

Bit select signals are input to the plurality of first selector circuits 48f, the plurality of second selector circuits 48g, the plurality of third selector circuits 48h, the plurality of fourth selector circuits 48k, and the plurality of fifth selector circuits 48j. The bit select signal is transmitted from, for example, an external control circuit. The first data D1 is constantly input to each of the plurality of first selector circuits 48f from the corresponding bit of the first register 48a. When the bit select signal is input, each of the plurality of first selector circuits 48f outputs some bits of the first data D1 to the adder 48e from the corresponding bit of the first register 48a. Specifically, the plurality of first selector circuits 48f sequentially output the first data D1 from the least significant bit A₀ among A₀ to A_{X-1}. The second data D2 is constantly input to each of the plurality of second selector circuits 48g from the corresponding bit of the second register 48b. When the bit select signal is input, each of the plurality of second selector circuits 48g outputs some bits of the second data D2 to the adder 48e from the corresponding bit of the second register 48b. Specifically, the plurality of second selector circuits 48g sequentially output the second data D2 from the least significant bit B₀ among B₀ to B_{Y+X-1}.

The adder 48e sequentially adds the first data D1 and the second data D2 from the least significant bit. In other words, the adder 48e repeatedly performs an operation of adding some bits of the first data D1 in the first register 48a and some bits of the second data D2 in the second register 48b corresponding to the bits of the first data D1 and outputs the result of the addition until all of the bits A₀ to A_{X-1} of the first data D1 are added. The carry generated at this time is held in the fourth register 48i and is reflected when the high-order digit is added. After all of the bits A₀ to A_{X-1} of the first data D1 and the bits B₀ to B_{X-1} of the second data D2 are added, the adder 48e adds the carry signal or 0 to the remaining bits B_{X} to B_{Y+X-1} of the second data D2. The carry signal described here is a carry signal generated when the most significant bit A_{X-1} of the first data D1 and the bit B_{X-1} of the second data D2 are added. After adding the carry signal and the corresponding bit of the second data D2, the adder 48e adds 0 and the second data D2 up to the most significant bit B_{Y+X-1} of the second data D2. In the second embodiment, even when the data items D1, D2, and D3 are held in the registers 48a, 48b, and 48d, respectively, the output of each of the registers 48a, 48b, and 48d is not updated and an indefinite value is output unless the bit to be output is designated by the bit select signal.

The result of the addition is input from the adder 48e to each of the plurality of third selector circuits 48h. When the bit select signals are input to each of the plurality of third selector circuits 48h, each of the plurality of third selector circuits 48h outputs the result of the addition to the corresponding bit of the third register 48d. As a result, each bit of the third data D3, which is the result of the addition of the first data D1 and the second data D2, is stored in each of the plurality of third registers 48d. The third data D3 is input to each of the plurality of fourth selector circuits 48k from the corresponding bit of the third register 48d. When the bit select signal is input, each of the plurality of fourth selector circuits 48k outputs the bit of the third data D3 to the pixel circuit 40 in the subsequent row from the corresponding bit of the third register 48d. Specifically, the plurality of fourth selector circuits 48k sequentially output the third data D3 stored in the bits S₀ to S_{Y+X-1} of the third register 48d from the least significant bit S₀.

Each bit of the third data D3 is sequentially input from the plurality of fourth selector circuits 48k of the pixel circuit 40 in the previous row to each of the plurality of fifth selector circuits 48j. The bit select signal is input to each of the plurality of fifth selector circuits 48j at the same timing as the bit select signals are input to the corresponding fourth selector circuits 48k. When the bit select signal is input, each of the plurality of fifth selector circuits 48j outputs some bits of the third data D3 to the corresponding bits of the second register 48b.

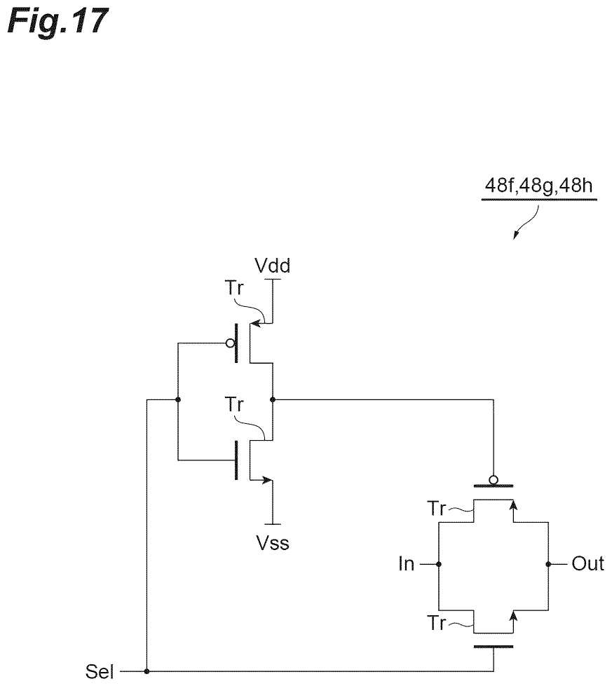

FIG. 17 is an example of a circuit diagram illustrating the selector circuit 48f, 48g, 48h, 48k, and 48j illustrated in FIG. 16. The selector circuit 48f, 48g, 48h, 48k, and 48j is a composite logic circuit including four transistors Tr. The bit select signal is input to a Se1 terminal. Some bits of each of the data items D1, D2, and D3 are input to In terminals from each of the registers 48a, 48b, and 48d. When the bit select signals are input to the Se1 terminals, the selector circuits 48f, 48g, 48h, 48k, and 48j output some bits of each of the data items D1, D2, and D3 from OUT terminals.

Here, the number of transistors required for the pixel circuit 48 (FIG. 8) according to the first embodiment is compared with the number of transistors required for the pixel circuit 48A (FIG. 16) according to the second embodiment. In the approximate calculation of the number of transistors, it is assumed that bits X, which is the maximum count value of the counter 47, is 12 bits and bits Y, which is the binary representation of M that is the number of rows of the plurality of pixel circuits 40, is 6 bits. The number of transistors required to configure the first register 48a is 132 (the number of bits: 12× the number of transistors: 11) in both the pixel circuit 48 according to the first embodiment and the pixel circuit 48A according to the second embodiment. The number of transistors required to configure each of the second register 48b and the third register 48d is 198 (the number of bits: 18× the number of transistors: 11) in both the pixel circuit 48 according to the first embodiment and the pixel circuit 48A according to the second embodiment. The number of transistors required to configure the adder 48c according to the first embodiment is 504 (the number of bits: 18× the number of transistors: 28), and the number of transistors required to configure the adder 48e according to the second embodiment is 28 (the number of bits: 1× the number of transistors: 28). In the pixel circuit 48A according to the second embodiment, 192 transistors (a total number of bits: 48× the number of transistors: 4) are required to configure the plurality of first selector circuits 48f, the plurality of second selector circuits 48g, and the plurality of third selector circuits 48h. Furthermore, in the pixel circuit 48A according to the second embodiment, 11 transistors (the number of bits: 1× the number of transistors: 11) are required to configure the fourth register 48i included in the adder 48e. From the above, the total number of transistors required for the pixel circuit 48 according to the first embodiment is 1032, and the total number of transistors required for the pixel circuit 48A according to the second embodiment is 759. In the pixel circuit 48A according to the second embodiment, the number of transistors is about 30% less than that in the pixel circuit 48 according to the first embodiment.

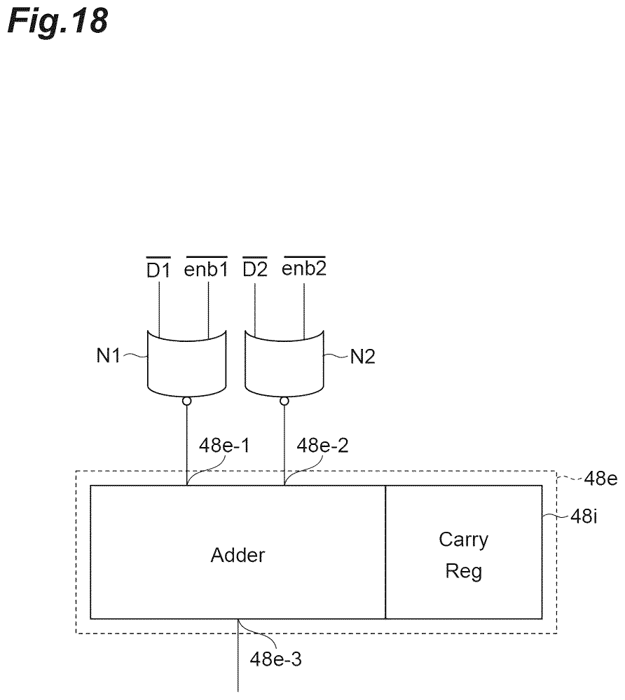

FIG. 18 is a diagram illustrating a configuration of input and output terminals of the adder 48e illustrated in FIG. 16. In the adder 48e, a NOR element N1 is provided on an input terminal 48e-1 to which the first data D1 is input from the first register 48a. In the adder 48e, a NOR element N2 is provided on an input terminal 48e-2 to which the second data D2 is input from the second register 48b. The NOR element N1 and the NOR element N2 have a function of switching between enable state and disable state. When an enable signal enb1 is input to the NOR element N1 (the NOR element N1 is enabled), the first data D1 is input to the input terminal 48e-1. On the other hand, when the enable signal enb1 is not input to the NOR element N1 (the NOR element N1 is disabled), ‘0’ is input to the input terminal 48e-1. When an enable signal enb2 is input to the NOR element N2 (the NOR element N2 is enabled), the second data D2 is input to the input terminal 48e-2. On the other hand, when the enable signal enb2 is not input to the NOR element N2 (the NOR element N2 is disabled), ‘0’ is input to the input terminal 48e-2. When both the NOR element N1 and the NOR element N2 are enabled, the third data D3 is output from an output terminal 48e-3 of the adder 48e. However, when only one of the NOR element N1 and the NOR element N2 is enabled, the enabled one of the first data D1 and the second data D2 is output from the output terminal 48e-3. As an alternative to the NOR element N1 and the NOR element N2, another logic circuit may be used that outputs the first data D1 only when the enable signal enb1 is being input (the input is 1).

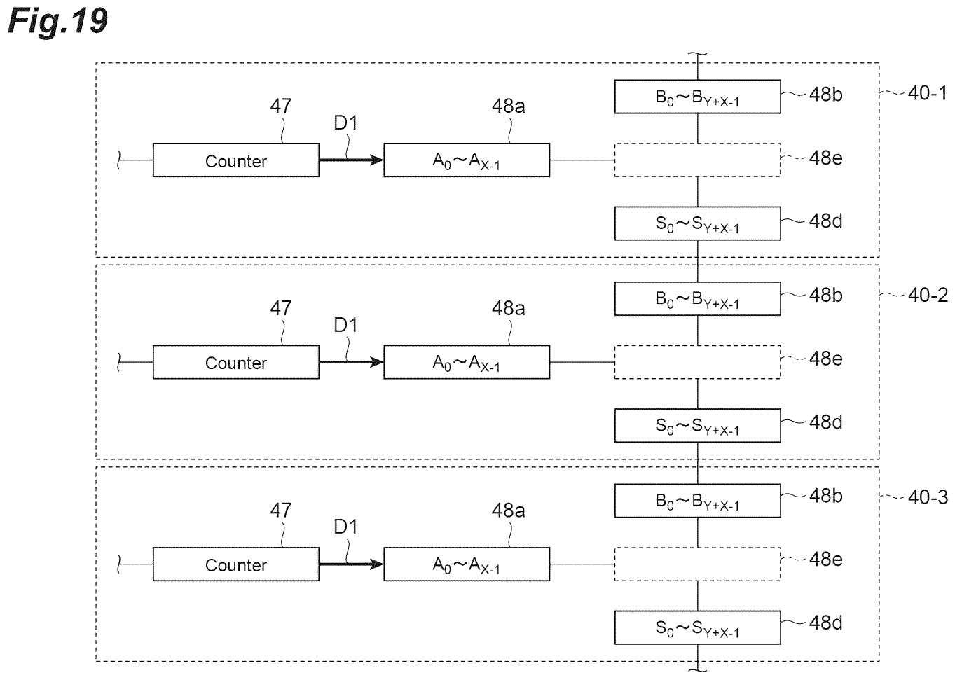

FIGS. 19 to 21 are diagrams illustrating the TDI operation in the pixel circuit 40 according to the second embodiment. The arrangement of the pixel circuits 40-1, 40-2, and 40-3, and the transfer direction of the third data D3 are the same as those in the first embodiment. As illustrated in FIG. 19, first, the first register 48a of each pixel circuit 40 holds the first data D1. At this time, the NOR element N1 is set to be disabled. Therefore, an invalid value is output from the adder 48e. When the NOR element N1 is set to be enabled, the output of the NOR element N1 changes depending on the output of the first register 48a. Therefore, an indeterminate value is output from the adder 48e. When the indeterminate value is not held in the third register 48d, there is no concern that the indeterminate value will be transferred to the subsequent pixel circuit 40, which does not cause any particular problem.

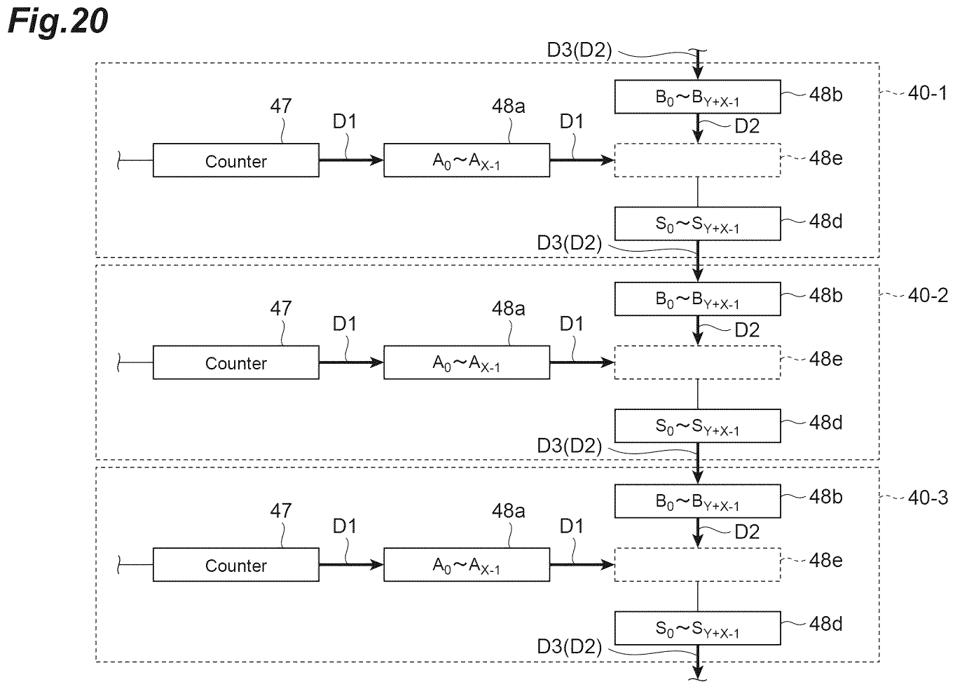

Then, as illustrated in FIG. 20, the least significant bit of each of the data items D1, D2, and D3 is output from each of the registers 48a, 48b, and 48d. A specific operation will be described using the pixel circuit 40-1 as an example. When the bit select signal is input, the fourth selector circuit 48k of the pixel circuit 40-1 outputs the least significant bit S₀ of the third data D3 from the third register 48d of the pixel circuit 40-1 to the fifth selector circuit 48j of the pixel circuit 40-2. When the bit select signal is input, the fifth selector circuit 48j of the pixel circuit 40-2 outputs the least significant bit S₀ of the third data D3 to the second register 48b of the pixel circuit 40-2. The second register 48b of the pixel circuit 40-2 holds the least significant bit S₀ of the transferred third data D3 as the least significant bit B₀ of the second data D2. Here, the bit select signal is also transmitted to the selector circuits 48f and 48g at the same time. Therefore, when the bit select signal is input, the first selector circuit 48f of the pixel circuit 40-1 outputs the least significant bit A₀ of the first data D1 from the first register 48a of the pixel circuit 40-1 to the adder 48e. When the bit select signal is input, the second selector circuit 48g of the pixel circuit 40-1 outputs the least significant bit B₀ of the second data D2 from the second register 48b of the pixel circuit 40-1 to the adder 48e. At that time, the NOR element N1 and the NOR element N2 are set to disable state such that the adder 48e does not operate.

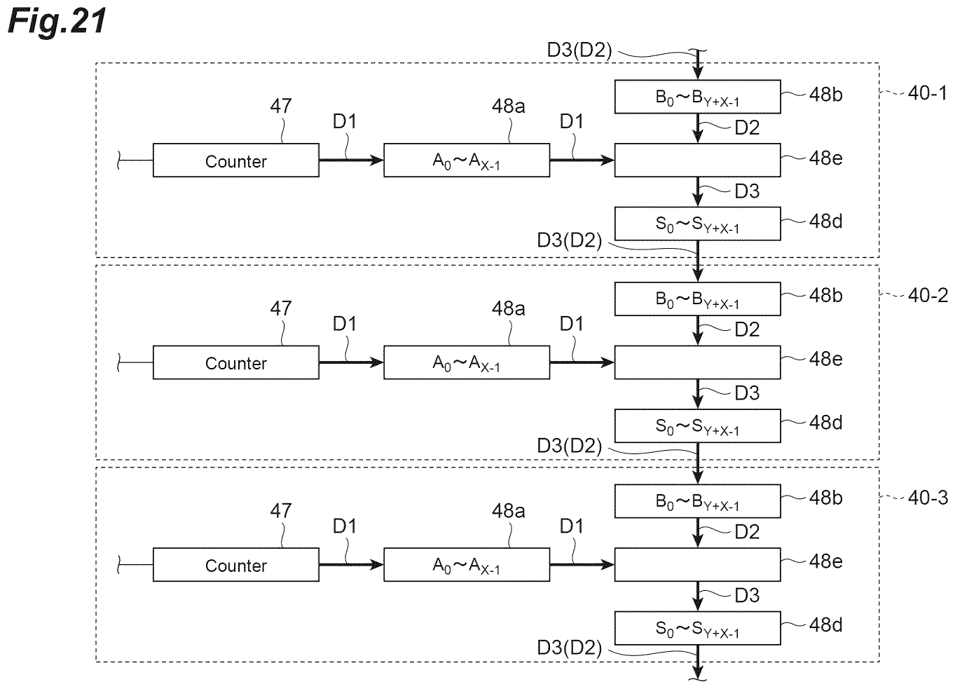

Then, as illustrated in FIG. 21, the NOR element N1 and the NOR element N2 are set to enable state. Then, the adder 48e adds the least significant bit A₀ of the first data D1 and the least significant bit B₀ of the second data D2 to generate the least significant bit S₀ of the third data D3. The least significant bit S₀ is input from the adder 48e to the third selector circuit 48h. When the bit select signal is input, the third selector circuit 48h outputs the least significant bit S₀ to the corresponding bit of the third register 48d. The third register 48d holds the least significant bit S₀ of the third data D3. The process described above with reference to FIGS. 19 and 20 is repeated in order from the least significant bits A₀, B₀, and S₀ to the most significant bits A_{X-1}, B_{Y+X-1}, and S_{Y+X-1} of the data items D1, D2, and D3. In this process, the adder 48e repeatedly performs the operation of adding some bits of the first data D1 and some bits of the second data D2 and outputting the result of the addition until all of the bits X of the first data D1 are added. After adding all of the bits A₀ to A_{X-1} of the first data D1 and the bits B₀ to B_{X-1} of the second data D2, the adder 48e adds the carry signal or 0 to the remaining bits B_{X} to B_{Y+X-1} of the second data D2. That is, after adding the carry signal and the corresponding bits of the second data D2, the adder 48e adds 0 and the second data D2 up to the most significant bit B_{Y+X-1} of the second data D2.

The pixel circuit 40 according to the second embodiment may be utilized as a global shutter in addition to the TDI operation. In this case, the timing when the first data D1 is held in the first register 48a is the same for all of the pixel circuits 40. Then, for example, when the first data D1 is read out from the pixel circuit 40-1, while the NOR element N1 of the adder 48e in the pixel circuit 40-1 is set to enable state, the NOR element N2 is set to disable state. Then, while the NOR element N1 of the adder 48e in each of the pixel circuits 40 from the pixel circuit 40-2 in the subsequent row to the pixel circuit 40 in the last row is set to disabled, the NOR element N2 is set to enabled. As a result, the addition process is not performed in each of the pixel circuits 40 from the pixel circuit 40-2 to the pixel circuit 40 in the last row, and the first data D1 of the pixel circuit 40-1 is sequentially transferred to the pixel circuit 40 in the subsequent row. Then, the first data D1 of the pixel circuit 40-1 is read out from the pixel circuit 40 in the last row. This operation is repeated from the pixel circuit 40 in the first row to the pixel circuit 40 in the last row. The pixel circuit 40 according to the second embodiment is utilized as the global shutter, which enables an operation of reading out a two-dimensional image. Alternatively, the pixel circuit 40 according to the second embodiment may be utilized as a rolling shutter. In this case, for example, in the operation of the global shutter, the timing when the first data D1 is held in the first register 48a is shifted between the pixel circuits 40 by a delay circuit or the like. Specifically, the timing when the first data D1 is held in the first register 48a in the pixel circuit 40-2 is delayed relative to the timing when the first data D1 is held in the first register 48a in the pixel circuit 40-1. Similarly, the timing when the first data D1 is held in the first register 48a in the pixel circuit 40-3 is delayed relative to the timing when the first data D1 is held in the first register 48a in the pixel circuit 40-2. As a result, the timing when the first data D1 is read out from each pixel circuit 40 is gradually shifted along the arrangement direction of the pixels.

### [Operation and Effect]

In the radiation detector 1, the number of bits of the second register 48b is the sum X+Y of the number of bits X of the first register 48a and the number of bits Y which is the binary representation of the number of pixel circuits 40, the number of bits of the adder 48e is smaller than the number of bits X+Y of the second register 48b, and the adder 48e repeatedly performs the operation of adding some bits of the first data D1 of the first register 48a and some bits of the second data D2 of the second register 48b corresponding to some bits of the first data D1 and outputting the result of the addition until all of the bits of the first data D1 are added. According to this configuration, since the number of bits of the adder 48e is smaller than the number of bits of the second register 48b, it is possible to reduce the area of the circuit. Meanwhile, the adder 48e repeatedly performs the operation of adding some bits of the first data D1 and some bits of the second data D2 and outputting the result of the addition until all of the bits of the first data D1 are added, which makes it possible to perform the addition process even with a small number of bits.

In the radiation detector 1, the number of bits of the adder 48e is one bit, and the adder 48e has the fourth register 48i for holding the carry signal. This makes it possible to reduce the area of the circuit and to perform carry calculation even when the number of bits of the adder 48e is one.

### MODIFICATION EXAMPLES

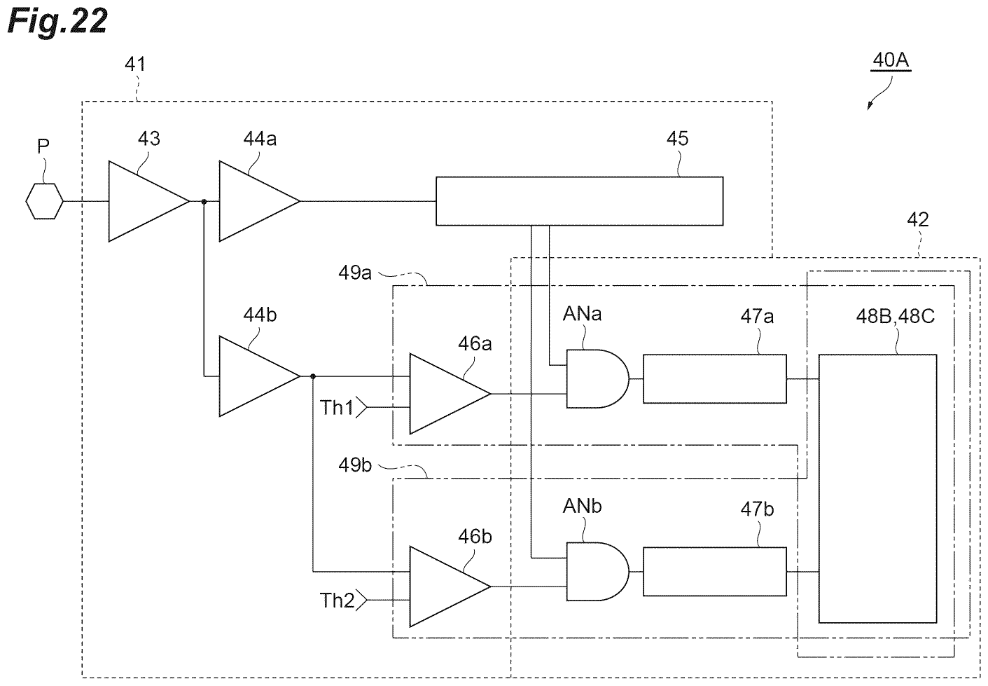

The present disclosure is not limited to the above-described embodiments. Each pixel circuit 40 may have a plurality of detection systems. FIG. 22 is a circuit block diagram illustrating a pixel circuit 40A according to a modification example. Only differences from the first and second embodiments will be described. Each pixel circuit 40A has a first detection system 49a and a second detection system 49b instead of the detection system 49 of the pixel circuit 40. The first detection system 49a includes a first comparator 46a instead of the comparator 46 of the detection system 49. The first detection system 49a includes a first AND circuit ANa instead of the AND circuit AN. The first detection system 49a includes a first counter 47a instead of the counter 47. The second detection system 49b includes a second comparator 46b instead of the comparator 46 of the detection system 49. The second detection system 49b includes a second AND circuit ANb instead of the AND circuit AN. The second detection system 49b includes a second counter 47b instead of the counter 47. The first detection system 49a and the second detection system 49b include a common pixel circuit 48B and 48C instead of the pixel circuit 48 and 48A. The output terminal of the shaper circuit 44b is connected to one of an inverting input terminal and a non-inverting input terminal of the first comparator 46a, the output terminal of the shaper circuit 44b is further connected to one of an inverting input terminal and a non-inverting input terminal of the second comparator 46b. The charge sharing countermeasure circuit 45 is connected to one of input terminals of the first AND circuit ANa and one of input terminals of the second AND circuit ANb. An output terminal of the first comparator 46a is connected to the other of the input terminals of the first AND circuit ANa. An output terminal of the second comparator 46b is connected to the other of the input terminals of the second AND circuit ANb. An output terminal of the first AND circuit ANa is connected to an input terminal of the first counter 47a. An output terminal of the second AND circuit ANb is connected to an input terminal of the second counter 47b. An output terminal of the first counter 47a and an output terminal of the second counter 47b are connected to the common pixel circuit 48B and 48C. A first threshold value Th1 is input to the other of the inverting input terminal and the non-inverting input terminal of the first comparator 46a. A second threshold value Th2 is input to the other of the inverting input terminal and the non-inverting input terminal of the second comparator 46b. The second threshold value Th2 may be larger or smaller than the first threshold value Th1 as long as it is different from the first threshold value Th1.

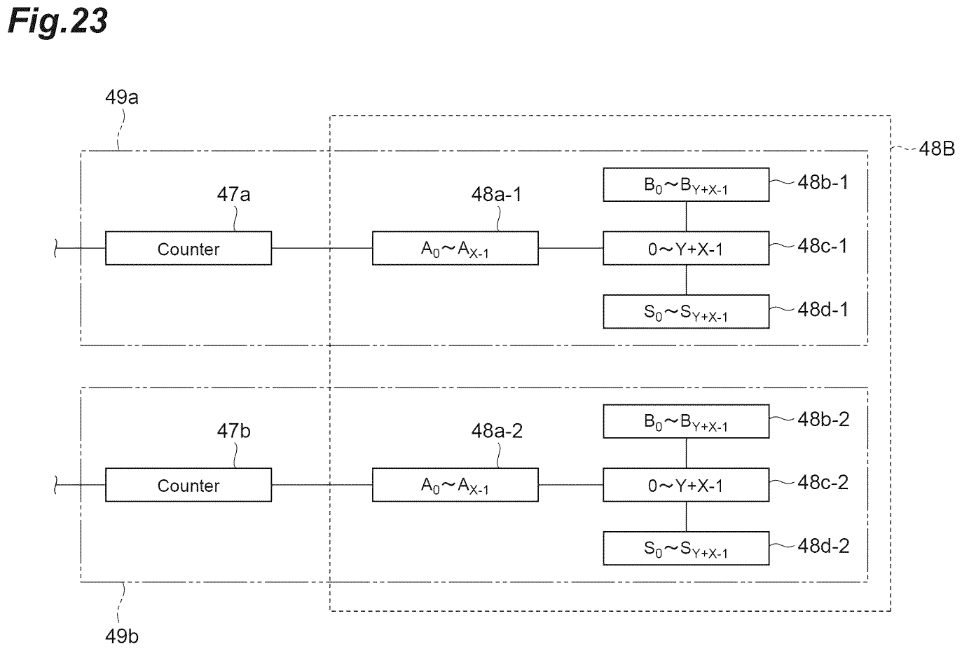

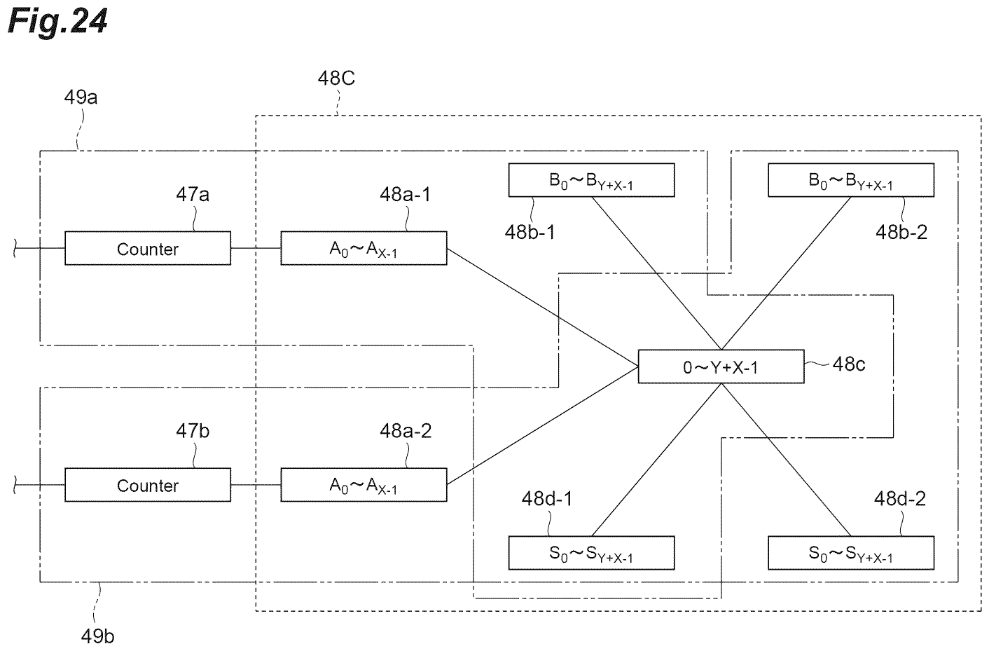

FIGS. 23 and 24 are circuit diagrams illustrating the pixel circuits 48B and 48C illustrated in FIG. 22, respectively. FIG. 23 is a circuit diagram illustrating the pixel circuit 48B when adders 48c-1 and 48c-2 of the first detection system 49a and the second detection system 49b are provided individually for each detection system. As illustrated in FIG. 23, the first detection system 49a includes a first register 48a-1, a second register 48b-1, the adder 48c-1, and a third register 48d-1 in the pixel circuit 48. The operations of the registers 48a-1, 48b-1, and 48d-1 are the same as those of the registers 48a, 48b, and 48d according to the first or second embodiment. The operation of the adder 48c-1 is the same as that of the adder 48c according to the first embodiment or the adder 48e according to the second embodiment. The second detection system 49b includes a first register 48a-2, a second register 48b-2, the adder 48c-2, and a third register 48d-2 in the pixel circuit 48. The operations of the registers 48a-2, 48b-2, and 48d-2 and the adder 48c-2 are the same as those of the registers 48a-1, 48b-1, and 48d-1 and the adder 48c-1 in the first detection system 49a, respectively. The first detection system 49a counts the number of hits of the radiation R based on the result of the comparison between the first threshold value Th1 and the first pulse signal PS1 by the first counter 47a. Then, the first detection system 49a sequentially transfers the third data D3 to the pixel circuit 40A provided corresponding to the pixel 2c adjacent to the corresponding pixel 2c in the first direction A1 illustrated in FIG. 2 (TDI operation). The second detection system 49b counts, by the second counter 47b, the number of hits of the radiation R based on the result of the comparison between the second threshold value Th2 and the first pulse signal PS1. Then, the second detection system 49b sequentially transfers the third data D3 to the pixel circuit 40A provided corresponding to the pixel 2c adjacent to the corresponding pixel 2c in the first direction A1 (TDI operation). FIG. 24 is a circuit diagram illustrating the pixel circuit 48C when the adder 48c of the first detection system 49a and the adder 48c of the second detection system 49b are common to each other. The common adder 48c has the functions of both the adder 48c-1 and the adder 48c-2 illustrated in FIG. 23. The common adder 48c does not perform the addition process in the first detection system 49a and the addition process in the second detection system 49b at the same time. For example, the common adder 48c does not receive an input from the second detection system 49b while performing the addition process in the first detection system 49a.

According to the radiation detector 1 including each pixel circuit 40A according to the above-described modification example, the energy level of the radiation R (the amount of carriers generated) can be detected separately by the first detection system 49a and the second detection system 49b. When the adders 48c-1 and 48c-2 of the first detection system 49a and the second detection system 49b are provided individually for each detection system, it is possible to perform the detection process in parallel in the plurality of detection systems and thus to improve the processing speed. When the adder 48c is shared between the first detection system 49a and the second detection system 49b, it is possible to reduce the area of each pixel circuit 40. Each pixel circuit 40A may have at least one detection system or may have three or more detection systems.

In the first and second embodiments, the adder 48c and 48e and each of the registers 48a, 48b, and 48d have been described as separate and independent components. However, the adder 48c and 48e may have the functions of at least one of the registers 48a, 48b, and 48d. For example, the adder 48c and 48e may have the function of the first register 48a and may hold the first data D1 output from the counter 47 in the adder 48c and 48e. In other words, the adder 48c and 48e may include at least one of the first register 48a holding the first data D1, the second register 48b holding the second data D2, and the third register 48d holding the third data D3. In this case, the detection system 49 has the other registers except at least one of the first register 48a, the second register 48b, and the third register 48d outside the adder 48c and 48e. Even in the above configuration, the radiation detector 1 and the integrated circuit 4 can have the same operation and effect as those of the embodiments.

The conversion unit 2, the plurality of pixel electrode portions 3, and the integrated circuit 4 may be formed on the same substrate (monolithic system). Alternatively, the conversion unit 2, the plurality of pixel electrode portions 3, and the integrated circuit 4 may be formed on separate substrates and then bonded to each other by bump bonding or the like (hybrid system). The radiation detector 1 may be a direct conversion type directly converting the radiation R into an electric signal (first pulse signal PS1) or may be an indirect conversion type that further includes a scintillator and converts the radiation R through the scintillator. The number of bits of the second register 48b and the third register 48d may be larger than X+Y bits.

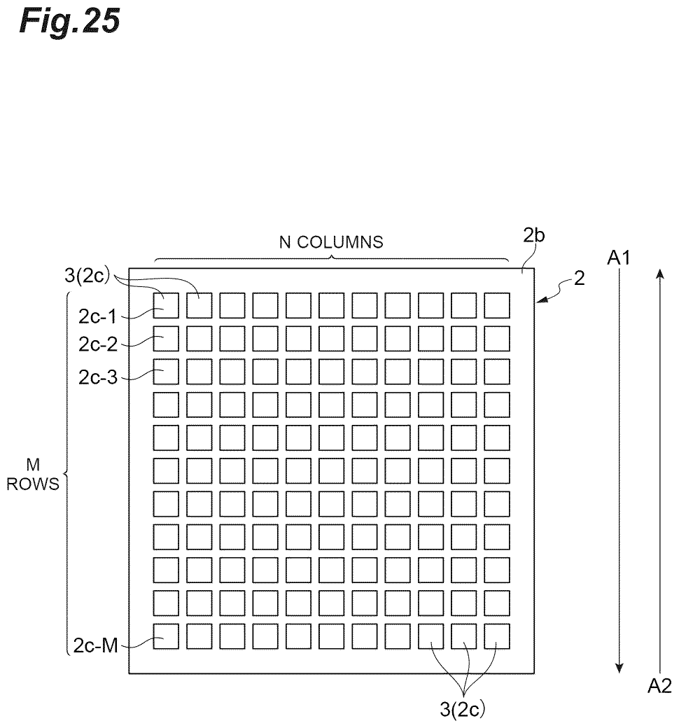

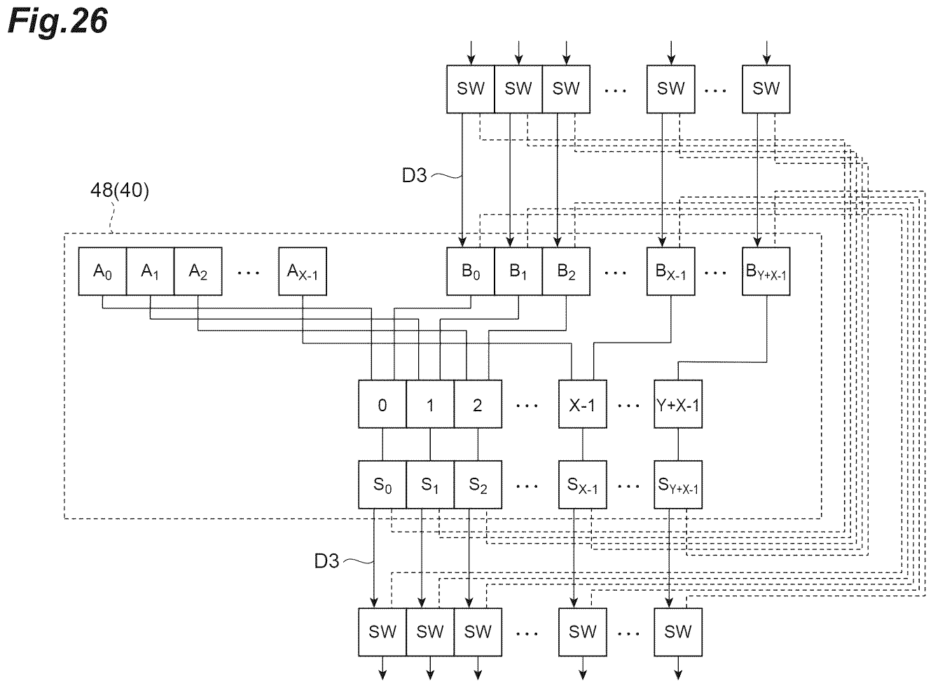

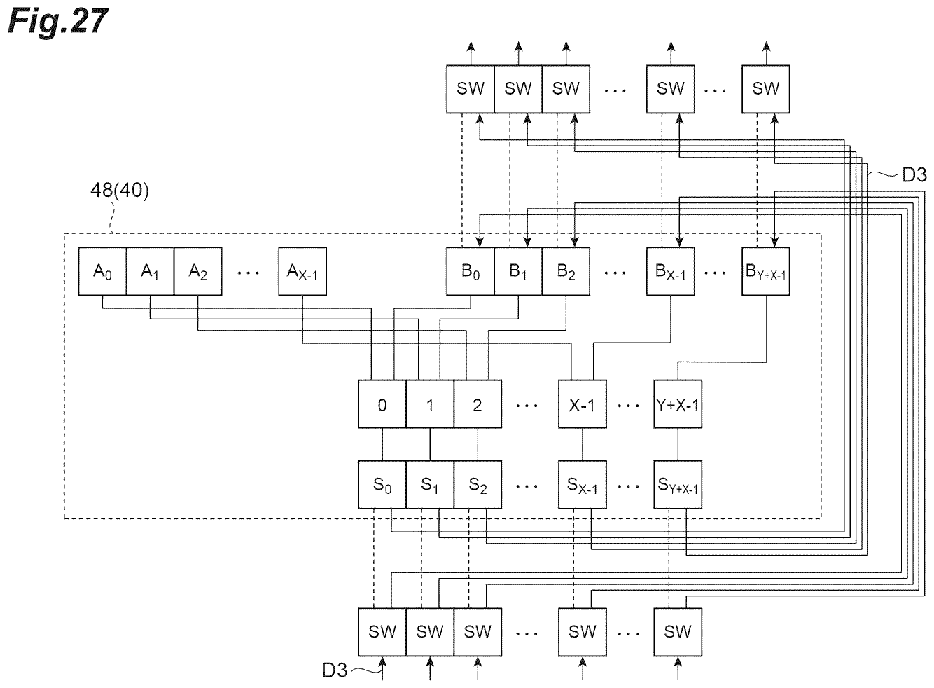

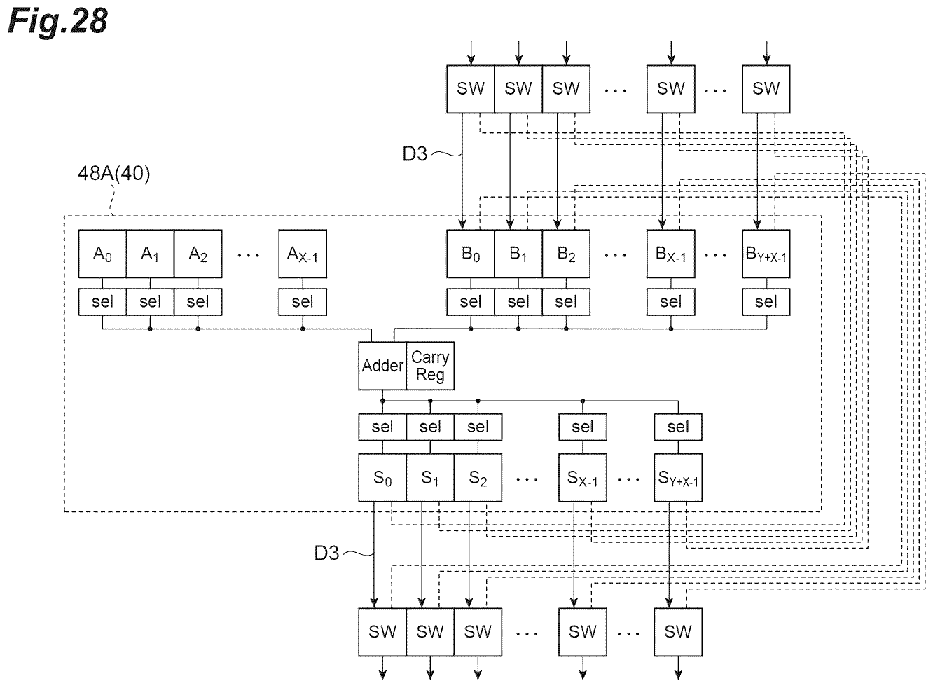

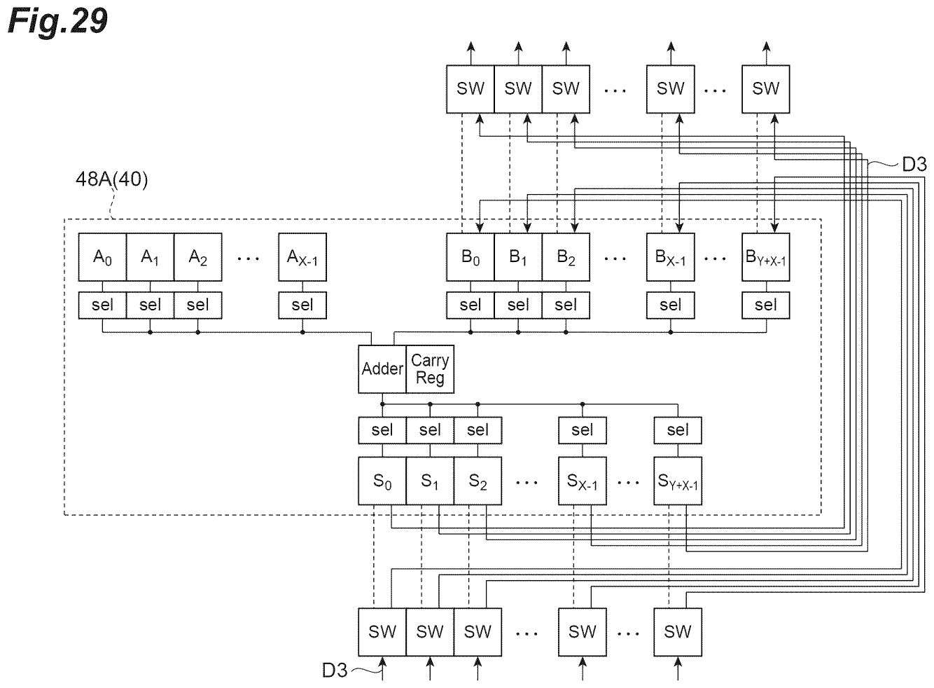

FIGS. 25 to 29 are drawings illustrating a transfer direction of the third data D3 in the pixel circuit 40 according to the modification example. As illustrated in FIG. 25, the radiation detector 1 may switch between a first TDI operation and a second TDI operation. The first TDI operation is a TDI operation of transferring the carriers generated in each pixel 2c to an adjacent pixel 2c along a first direction in each column. The first TDI operation is, for example, an operation of transferring from the pixel 2c-2 to the pixel 2c-3. The second TDI operation is a TDI operation of transferring to an adjacent pixel 2c along a second direction A2 opposite to the first direction. The second TDI operation is, for example, an operation of transferring from the pixel 2c-2 to the pixel 2c-1. FIGS. 26 and 27 illustrate the pixel circuit 48 of the pixel circuit 40 according to the first embodiment, and FIGS. 28 and 29 illustrate the pixel circuit 48A of the pixel circuit 40 according to the second embodiment. In the first and second embodiments, a plurality of pixel circuits 40 may switch the transport direction of the third data D3 such that the transport direction of the carriers in a plurality of pixels 2c can switch between the first direction A1 and the second direction A2. The transfer direction of the third data D3 may be switched by, for example, a plurality of changeover switches SW (switching units) whose number is equal to the number of bits X+Y of the second register 48b and the third register 48d. As illustrated in FIGS. 26 and 28, the plurality of changeover switches SW may set the transfer direction of the third data D3 such that the transfer direction of the carriers in the plurality of pixels 2c becomes the first direction A1. Alternatively, as illustrated in FIGS. 27 and 29, the plurality of changeover switches SW may set the transfer direction of the third data D3 such that the transfer direction of the carriers in the plurality of pixels 2c becomes the second direction A2. In other words, the plurality of changeover switches SW switch between an operation of transferring the third data D3 such that the transfer direction of the carriers is the first direction A1 and an operation of transferring the third data D3 such that the transfer direction of the carriers is the second direction A2. The switching of the transfer direction between the first direction A1 and the second direction A2 by the plurality of changeover switches SW may be performed at any timing or may be performed with the passage of a predetermined period of time. The provision of the plurality of changeover switches SW makes it possible for the plurality of pixel circuits 40 to transfer the third data D3 in both directions. Only the pixel circuit 40 is illustrated in FIGS. 26 to 29. However, this modification example can also be applied to the pixel circuit 40A. In this case, the plurality of changeover switches SW switch between the operation of transferring the third data D3 such that the transport direction of the carrier is the first direction A1 and the operation of transferring the third data D3 such that the transport direction of the carrier is the second direction A2 in each of the first detection system 49a and the second detection system 49b.

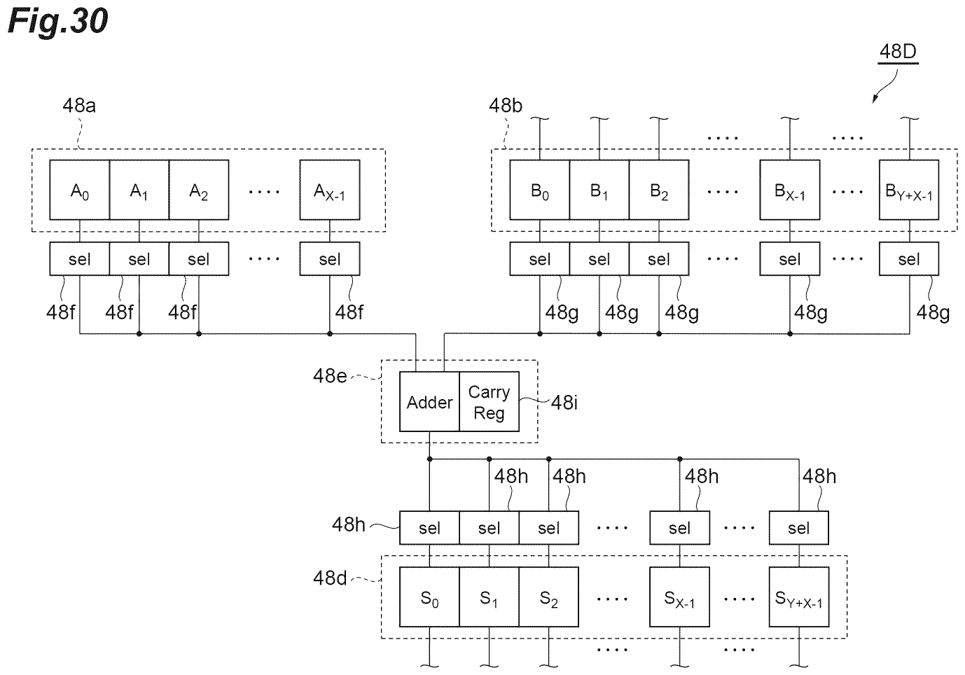

FIG. 30 is a diagram illustrating a detailed configuration of a pixel circuit 48D of a pixel circuit 40 according to a modification example. Only differences from the pixel circuit 48A according to the second embodiment will be described. As illustrated in FIG. 29, in the pixel circuit 48D, the third register 48d and the second register 48b of the pixel circuit 40 in the subsequent row may be directly connected in parallel, without passing through a plurality of fourth selector circuits 48k and a plurality of fifth selector circuits 48j. In this case, the third data D3 is directly output from each bit of the third register 48d to the corresponding bit of the second register 48b of the pixel circuit 40 in the subsequent row.

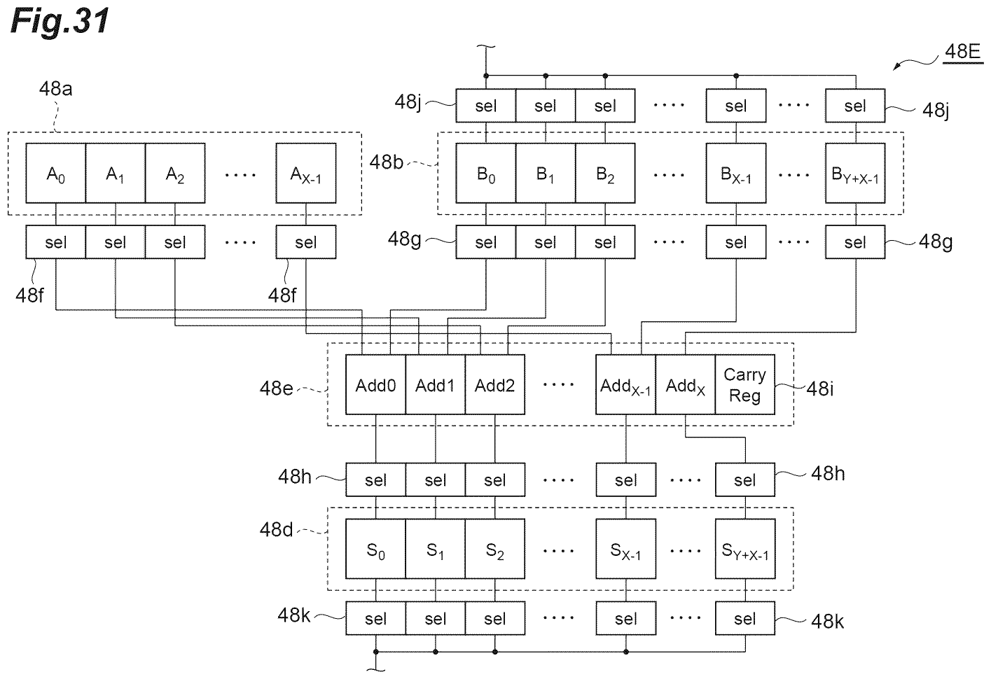

FIG. 31 is a diagram illustrating a detailed configuration of a pixel circuit 48E of a pixel circuit 40 according to a modification example. Only differences from the pixel circuit 48A according to the second embodiment will be described. As illustrated in FIG. 30, in the pixel circuit 48E, the number of bits of the adder 48e is bit X+1. The adder 48e performs the process of adding the first data D1 and the second data D2 in parallel from bit 0 to bit X−1. The adder 48e transmits the addition results from bit 0 to bit X−1 to the corresponding bits of the third selector circuit 48h in parallel. After all of the bits A₀ to A_{X-1} of the first data D1 are added, the adder 48e performs the addition of the carry signal and the remaining bits of the second data D2 at an (X+1)-th bit (Addx) of the adder 48e. Here, the carry signal is a carry signal generated when the most significant bit A_{X-1} of the first data D1 is added to the bit B_{X-1} of the second data D2. The carry signal is held in the fourth register 48i. After adding the most significant bit A_{X-1} of the first data D1 to the bit B_{X-1} of the second data D2, the adder 48e adds 0 and the second data D2 up to the most significant bit B_{Y+X-1} of the second data D2 at the (X+1)-th bit (Addx) of the adder 48e. In the pixel circuit 48E, each bit of the first register 48a and the bits 0 to X−1 of the adder 48e are connected in parallel to each other. Therefore, the pixel circuit 48E may not include the selector circuit 48f. Similarly, the pixel circuit 48E may not include the selector circuit 48g from bit 0 to bit X−1 and the selector circuit 48h from bit 0 to bit X−1. In the pixel circuit 48E that does not include the above-described selector circuits, the processing speed can be improved more than that of the pixel circuit 48A according to the second embodiment. In the pixel circuit 48E that does not include the above-described selector circuits, the area of the pixel circuit can be smaller than that of the pixel circuit 48 according to the first embodiment.

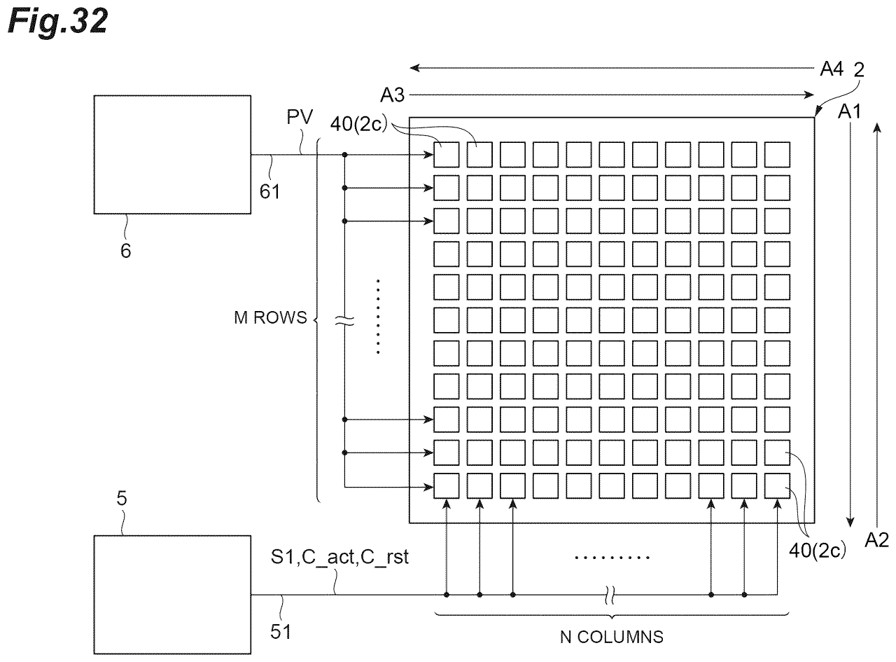

In the first embodiment, the second embodiment, and the modification examples, the first data D1 may be held in the first register 48a at the same time in all of the pixel circuits 40 constituting the plurality of pixel circuits 40. FIG. 32 is a drawing illustrating an example of the conversion unit 2, a power supply 6, and a control unit 5. FIG. 32 illustrates M×N pixel circuits 40. The power supply 6 supplies a power supply voltage PV to each pixel circuit 40 through a power transmission line 61. In the example illustrated in FIG. 32, the power transmission line 61 is branched into M rows along the column direction (the first direction A1 or the second direction A2). The power transmission line 61 branched into M rows is connected to each pixel circuit 40 along the row direction.

The control unit 5 transmits a first hold signal S1, a counter operation signal C_act, and a counter reset signal C_rst to each pixel circuit 40 through a signal line 51. In the example illustrated in FIG. 32, the signal line 51 is branched into N columns along the row direction (a third direction A3 or a fourth direction A4 perpendicular to the first direction A1 and the second direction A2). The signal line 51 branched into N columns is connected to each pixel circuit 40 along the column direction. While the power transmission line 61 is branched in the column direction, the signal line 51 is branched in the row direction. That is, the direction in which the power transmission line 61 is branched intersects the direction in which the signal line 51 is branched.

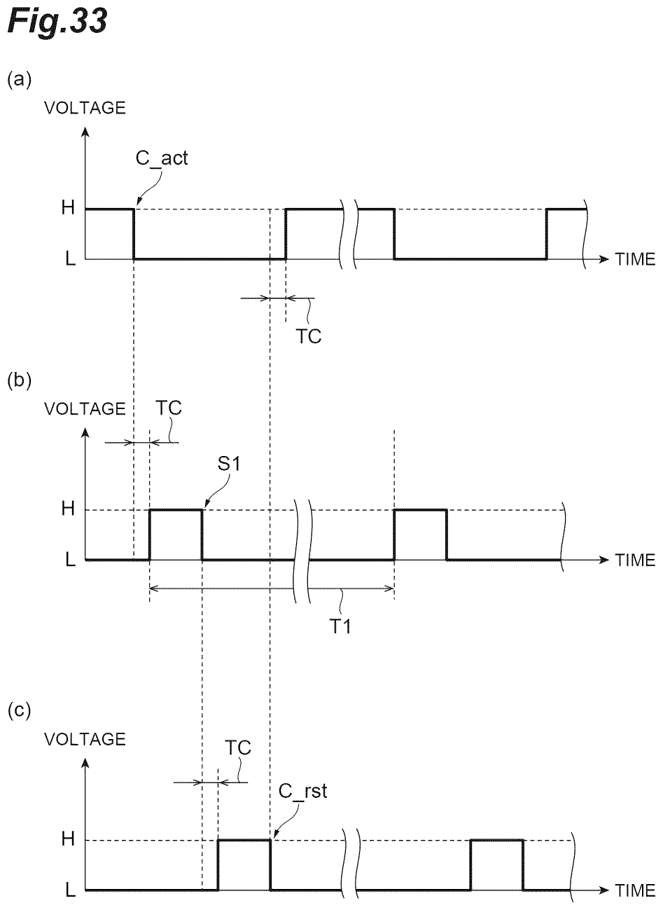

FIG. 33 is a drawing illustrating the first hold signal S1, the counter operation signal C_act, and the counter reset signal C_rst. In graphs illustrated in (a) to (c) of FIG. 33, the vertical axis indicates a voltage value, and the horizontal axis indicates time. While the counter operation signal C_act illustrated in (a) of FIG. 33 is at a high level, the counter 47 operates. As illustrated in (b) of FIG. 33, the counter operation signal C_act falls from the high level to a low level, and after an adjustment time TC has elapsed, the first hold signal S1 rises from the low level to the high level. While the counter operation signal C_act is at the low level, the counter 47 is stopped. In synchronization with the rising edge of the first hold signal S1, the first data D1 is held in the first register 48a in all of the pixel circuits 40 at the same time. Thereafter, the first hold signal S1 falls from the high level to the low level. After the adjustment time TC has elapsed, the counter reset signal C_rst rises from the low level to the high level to reset the counter 47. Then, the counter reset signal C_rst falls and after the adjustment time TC has elapsed, the counter operation signal C_act rises from the low level to the high level, and the counter 47 starts operating again. Here, the reason for providing the adjustment time TC will be described. The signal line 51 has parasitic resistance and parasitic capacitance which can cause a delay in signal transmission. In particular, there is a case where the delay in signal transmission is larger for the pixel circuit 40 farther away from the control unit 5. When the delay in signal transmission occurs, for example, a period occurs during which both the counter operation signal C_act and the first hold signal S1 are at the high level. During the period, the first data D1 is inadvertently held in the first register 48a while the counter 47 is operating. The adjustment time TC is adjusted such that the periods during which each signal is at the high level do not overlap each other. In the example illustrated in FIG. 33, the adjustment time TC from when the counter operation signal C_act falls to when the first hold signal S1 rises, the adjustment time TC from when the first hold signal S1 falls to when the counter reset signal C_rst rises, and the adjustment time TC from when the counter reset signal C_rst falls to when the counter operation signal C_act rises are the same time. However, the adjustment times may be different from each other.

The first hold signal S1 is a pulse signal in which one pulse is output at a period T. The one pulse stated here means a waveform in which a voltage value changes from a low level to a high level, remains at the high level for a predetermined period, and then falls from the high level to the low level. The length of one period T corresponds to one frame operation. The one frame operation is, for example, an operation from when a plurality of pixel circuits 40 hold the first data D1 to when the third data D3 is output from the pixel circuit 40 corresponding to the pixel 2c-M (see FIG. 2) in the last row.

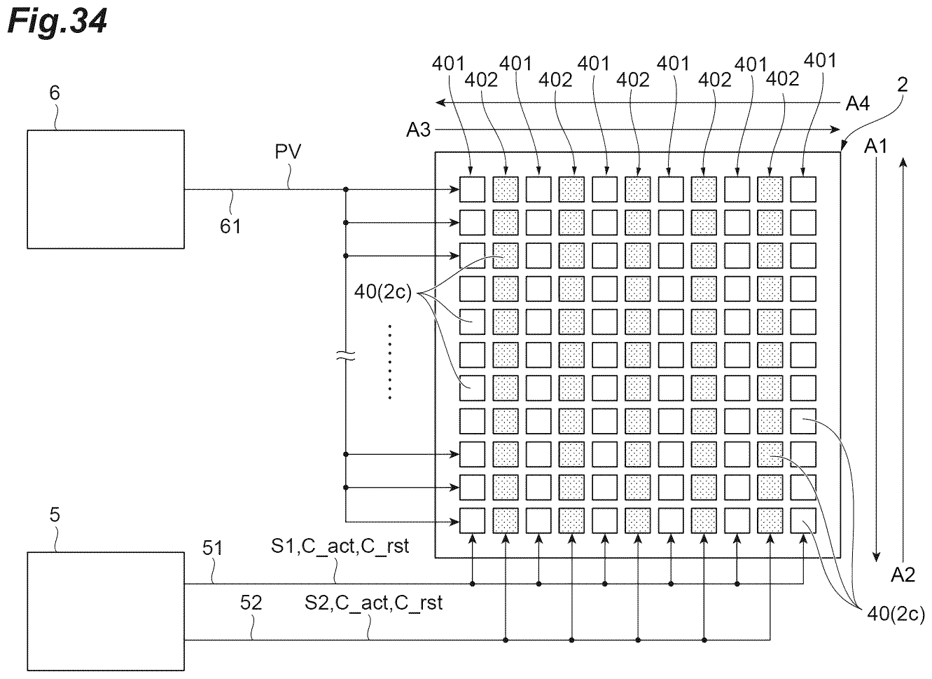

In the first embodiment, the second embodiment, and the modification examples, the plurality of pixel circuits 40 may be divided into a first pixel circuit region and a second pixel circuit region. Then, the timing when the first data D1 is held in the first register 48a may be different between the first pixel circuit region and the second pixel circuit region. FIG. 34 is a diagram illustrating an example of the plurality of pixel circuits 40 divided into a first pixel circuit region 401 and a second pixel circuit region 402. As illustrated in FIG. 34, each of the first pixel circuit region 401 and the second pixel circuit region 402 may be set in units of one column. The first pixel circuit region 401 and the second pixel circuit region 402 may be alternately set along the third direction A3 (row direction). The number of signal lines for outputting signals from the control unit 5 may be two or more. In the example illustrated in FIG. 34, the signal lines for outputting the signals from the control unit 5 are a signal line 51 and a signal line 52. The control unit 5 transmits the first hold signal S1, the counter operation signal C_act, and the counter reset signal C_rst to the first pixel circuit region 401 among the pixel circuits 40 through the signal line 51. The control unit 5 transmits a second hold signal S2, the counter operation signal C_act, and the counter reset signal C_rst to the second pixel circuit region 402 among the pixel circuits 40 through the signal line 52. The number of signal lines for outputting the signals from the control unit 5 may be one. In this case, for example, one signal line for outputting the signals from the control unit 5 may be branched into a line for transmitting signals to the first pixel circuit region 401 and a line for transmitting signals to the second pixel circuit region 402. The control unit 5 may switch between the line for transmitting the signals to the first pixel circuit region 401 and the line for transmitting the signals to the second pixel circuit region 402 using switch circuits disposed between the control unit 5 and the first and second pixel circuit regions 401 and 402. For example, the control unit 5 may turn on and off switches of the switch circuits according to the timing when the first hold signal S1 is transmitted to the first pixel circuit region 401 and the timing when the second hold signal S2 is transmitted to the second pixel circuit region 402.

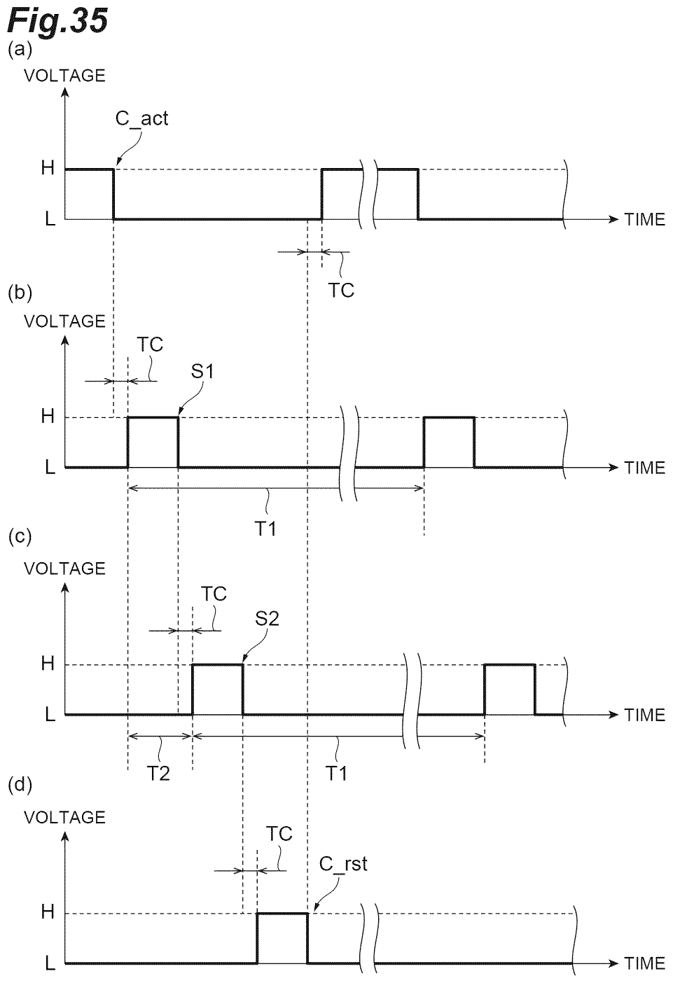

FIG. 35 is a drawing illustrating the first hold signal S1 and the second hold signal S2. The operations of the counter operation signal C_act and the counter reset signal C_rst are the same as those in FIG. 33. The control unit 5 transmits the first hold signal S1 to the first pixel circuit region 401 and transmits the second hold signal S2 to the second pixel circuit region 402. Each of the first hold signal S1 and the second hold signal S2 is a pulse signal in which one pulse is output with the period T1. However, the first hold signal S1 and the second hold signal S2 have different phases. Specifically, there is a time difference T2 between when the first hold signal S1 rises from a low level to a high level as illustrated in (b) of FIG. 35 and when the second hold signal S2 rises from a low level to a high level as illustrated in (c) of FIG. 35. As a result, after the time difference T2 has elapsed from the timing when the first data D1 is held in the first register 48a in the first pixel circuit region 401, the first data D1 is held in the first register 48a in the second pixel circuit region 402.

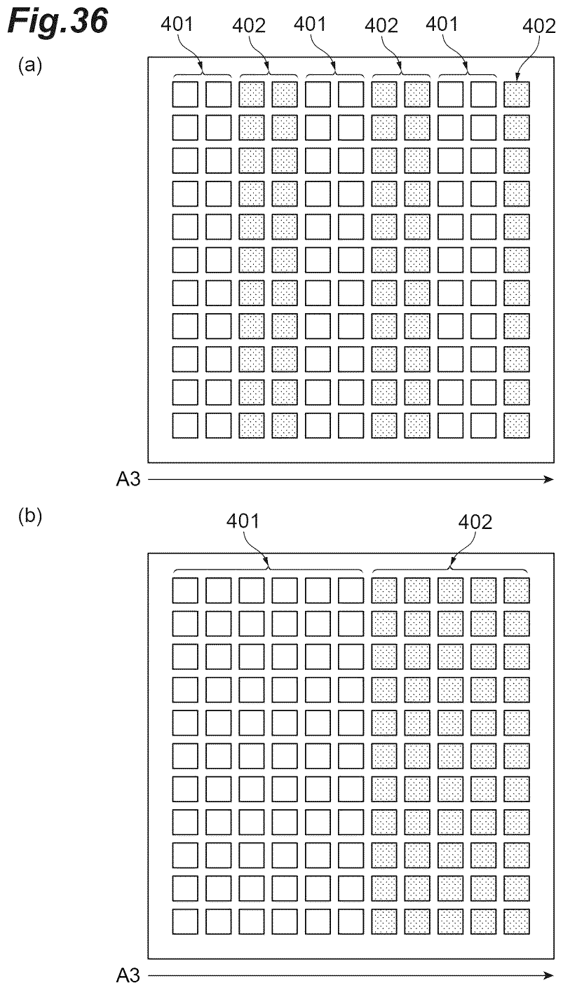

FIGS. 36 to 38 are drawings illustrating other examples of the first pixel circuit region 401 and the second pixel circuit region 402. FIGS. 36 to 38 illustrate M×N pixel circuits 40. As illustrated in FIG. 36, each of the first pixel circuit region 401 and the second pixel circuit region 402 may be set in units of a plurality of columns. As illustrated in (a) of FIG. 36, a plurality of columns of the first pixel circuit regions 401 and a plurality of columns of the second pixel circuit regions 402 may be alternately set along the third direction A3. Alternatively, as illustrated in (b) of FIG. 36, the first pixel circuit region 401 and the second pixel circuit region 402 may be set so as to divide a plurality of pixel circuits 40 into two groups along the third direction A3.

In the examples illustrated in FIGS. 34 and 36, while the power transmission line 61 is branched in the column direction, the first pixel circuit regions 401 and the second pixel circuit regions 402 are divided in the row direction. That is, the direction in which the power transmission line 61 is branched intersects the direction in which the first pixel circuit region 401 and the second pixel circuit region 402 are divided.

As illustrated in FIG. 33, when the first data D1 is held in the first register 48a at the same time in all of the pixel circuits 40, a large number of digital circuits are operated at the same time, which results in a temporary fluctuation in the power supply voltage PV. As a result, there is a concern that crosstalk will occur between the pixel circuits 40. The plurality of pixel circuits 40 are divided into the first pixel circuit region 401 and the second pixel circuit region 402, and the timing when the first data D1 is held in the first register 48a is different between the first pixel circuit region 401 and the second pixel circuit region 402, which makes it possible to reduce the amount of fluctuation in the power supply voltage PV and to reduce the risk of the crosstalk. In addition, the direction in which the power transmission line 61 is branched intersects the direction in which the first pixel circuit region 401 and the second pixel circuit region 402 are divided, and the first pixel circuit region 401 and the second pixel circuit region 402 are mixed on the branched power transmission line 61, which makes it possible to further reduce risk of the crosstalk.

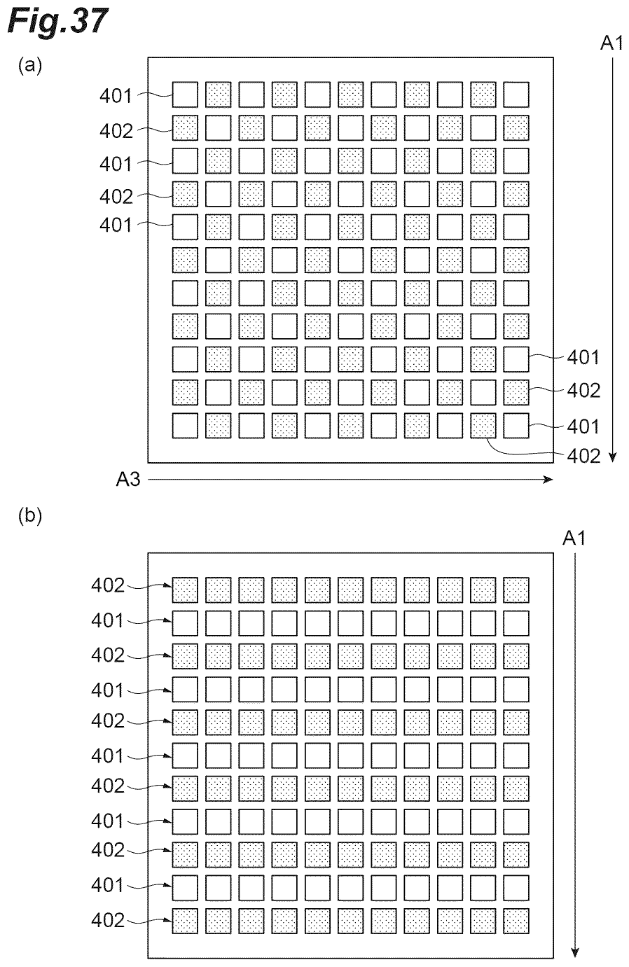

As illustrated in (a) of FIG. 37, the first pixel circuit region 401 and the second pixel circuit region 402 may be alternately set pixel by pixel along the third direction A3 (row direction) and the first direction A1 (column direction). In other words, the first pixel circuit regions 401 and the second pixel circuit regions 402 may be set pixel by pixel to form a checkerboard pattern.

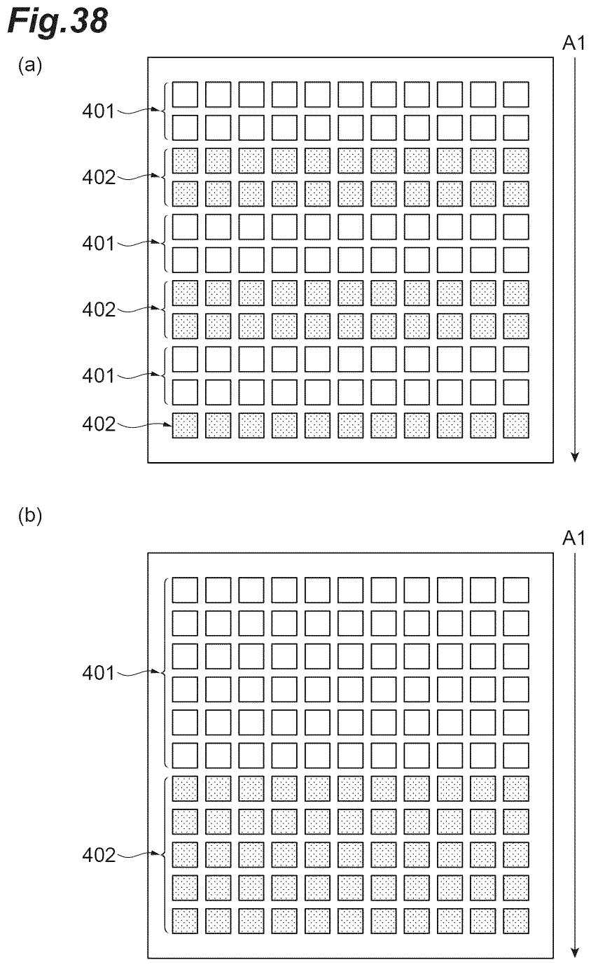

As illustrated in (b) of FIG. 37, the first pixel circuit regions 401 and the second pixel circuit regions 402 may be set in units of one row. The first pixel circuit regions 401 and the second pixel circuit regions 402 may be alternately set along the first direction A1 (column direction). As illustrated in FIG. 38, the first pixel circuit regions 401 and the second pixel circuit regions 402 may be set in units of a plurality of rows. As illustrated in (a) of FIG. 38, a plurality of rows of the first pixel circuit regions 401 and a plurality of rows of the second pixel circuit region 402 may be set alternately along the first direction A1. Alternatively, as illustrated in (b) of FIG. 38, the first pixel circuit region 401 and the second pixel circuit region 402 may be set so as to divide a plurality of pixel circuits 40 into two groups along the first direction A1.

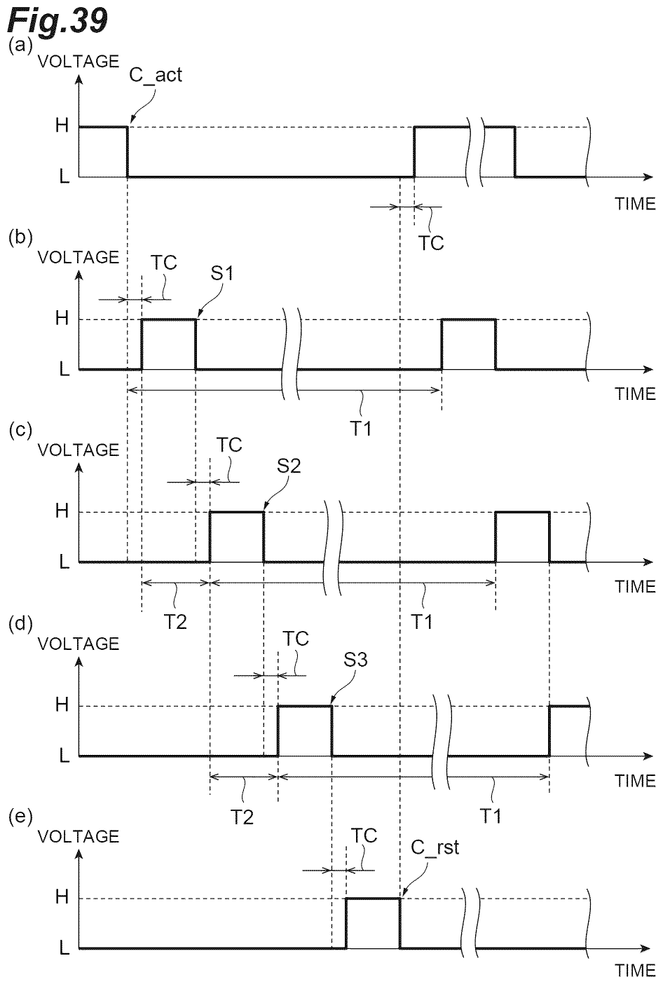

In the first embodiment, the second embodiment, and the above modification examples, the plurality of pixel circuits 40 may be divided into the first pixel circuit region, the second pixel circuit region, and a third pixel circuit region. Then, the first data D1 may be held in the first register 48a at different timings in the first pixel circuit region, the second pixel circuit region, and the third pixel circuit region. FIG. 39 is a drawing illustrating the first hold signal S1, the second hold signal S2, and a third hold signal S3. The operations of the counter operation signal C_act and the counter reset signal C_rst are the same as those in FIG. 33. The control unit 5 transmits the first hold signal S1 to the first pixel circuit region, transmits the second hold signal S2 to the second pixel circuit region, and transmits the third hold signal S3 to the third pixel circuit region. The third hold signal S3 is a pulse signal in which one pulse is output with the period T, like the first hold signal S1 and the second hold signal S2. However, the first hold signal S1, the second hold signal S2, and the third hold signal S3 have different phases. Specifically, there is the time difference T2 between when the first hold signal S1 rises from the low level to the high level as illustrated in (b) of FIG. 39 and when the second hold signal S2 rises from the low level to the high level as illustrated in (c) of FIG. 39. There is the time difference T2 between when the second hold signal S2 rises from the low level to the high level and when the third hold signal S3 rises from the low level to the high level as illustrated in (d) of FIG. 39. As a result, after the time difference T2 has elapsed from the timing when the first data D1 is held in the first register 48a in the first pixel circuit region, the first data D1 is held in the first register 48a in the second pixel circuit region. In addition, after the time difference T2 has elapsed from the timing when the first data D1 is held in the first register 48a in the second pixel circuit region, the first data D1 is held in the first register 48a in the third pixel circuit region.

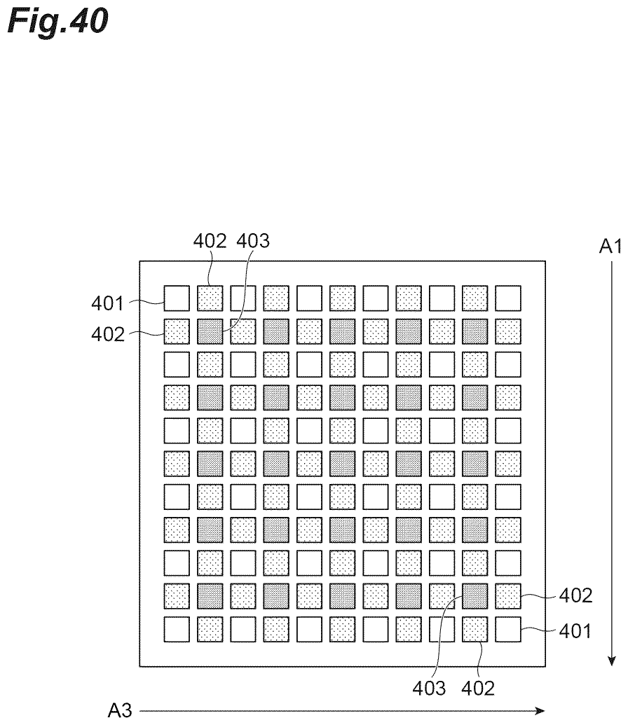

As illustrated in FIG. 40, columns configured by the first pixel circuit regions 401 and the second pixel circuit regions 402 and columns configured by the second pixel circuit regions 402 and the third pixel circuit regions 403 may be alternately set along the third direction A3 (row direction). In the column configured by the first pixel circuit regions 401 and the second pixel circuit regions 402, the first pixel circuit regions 401 and the second pixel circuit regions 402 may be alternately set pixel by pixel along the first direction A1 (column direction). In the column configured by the second pixel circuit regions 402 and the third pixel circuit regions 403, the second pixel circuit regions 402 and the third pixel circuit regions 403 may be alternately set pixel by pixel along the column direction.

In the above-described example, the form in which the plurality of pixel circuits 40 are divided into two pixel circuit regions, that is, the first pixel circuit region 401 and the second pixel circuit region 402, and the form in which the plurality of pixel circuits 40 are divided into three pixel circuit regions, that is, the first pixel circuit region 401, the second pixel circuit region 402, and the third pixel circuit region 403, have been described. The form in which the plurality of pixel circuits 40 are divided is not limited to the above, and the plurality of pixel circuits 40 may be divided into four or more pixel circuit regions. In this case, the timing when the first data D1 is held in the first register 48a is different among the four or more pixel circuit regions, which makes it possible to further reduce the risk of the crosstalk.

### [Supplementary Note]

The radiation detector 1 described above includes the first register 48a holding the first data D1 which is the count value of the counter 47. However, it is possible to omit the first register 48a. That is, the radiation detector may include: a conversion unit 2 including a plurality of pixels 2c generating carriers in response to incident radiation R, the plurality of pixels 2c being arranged along a predetermined direction; and a plurality of pixel circuits 40 each of which is provided corresponding to each of the plurality of pixels 2c and has at least one detection system 49 reading out carriers from the corresponding pixel 2c. The at least one detection system 49 may include: a comparator 46 that compares a first pulse signal PS1 based on an amount of carriers with a threshold value Th and outputs a second pulse signal PS2 when the first pulse signal PS1 exceeds the threshold value Th; a counter 47 counting the number of second pulse signals PS2; a second register 48b holding second data D2; an adder 48c and 48e adding the first data D1, which is the count value of the counter 47, and the second data D2 to generate third data D3; and a third register 48d holding the third data D3. The second data D2 may be the third data D3 transferred from the third register 48d of the pixel circuit 40 provided corresponding to the pixel 2c adjacent to the corresponding pixel 2c in each of the plurality of pixel circuits 40. All of the above-described embodiments and modification examples can be applied to the radiation detector in which the first register 48a is omitted as described above. For example, this radiation detector may have the pixel circuit 48 according to the first embodiment, and the number of bits of the adder 48c may be X+Y that is equal to the number of bits of the second register 48b and the third register 48d. Alternatively, this radiation detector may have the pixel circuit 48A according to the second embodiment, and the number of bits of the adder 48e may be one. This radiation detector may switch between the first TDI operation and the second TDI operation. The first TDI operation is a TDI operation of transferring the carriers generated in each pixel 2c to an adjacent pixel 2c along the first direction A1 for each column. The second TDI operation is a TDI operation of transferring to the adjacent pixel 2c along the second direction A2 which is an opposite direction to the first direction A1. This radiation detector may also be utilized as a rolling shutter in addition to the TDI operation. In this radiation detector, the detection system 49 of each of the plurality of pixel circuits 40 has the second register 48b holding, as the second data D2, the third data D3 transferred from the third register 48d in the pixel circuit 40 provided corresponding to the pixel 2c adjacent to the corresponding pixel 2c, the adder 48c adding the first data D1, which is the count value of the counter 47, and the second data D2 to generate the third data D3, and the third register 48d holding the generated third data D3. This configuration makes it unnecessary to write (load) the count value in the pixel circuit 40 in the previous stage to the counter 47 of each pixel circuit 40. Therefore, it is possible to shorten the non-operation period of the counter 47. As a result, it is possible to increase the proportion of the operation period of the counter 47 in each pixel circuit 40, that is, the period during which the radiation R can be detected, to the entire operation period of the pixel circuit 40.

### REFERENCE SIGNS LIST

1: radiation detector, 2: conversion unit, 2c: pixel, 4: integrated circuit, 40, 40-1, 40-2, 40-3, 40A: pixel circuit, 41: first region, 42: second region, 44a, 44b: shaper circuit, 45: charge sharing countermeasure circuit, 46: comparator, 47: counter, 48a, 48a-1, 48a-2: first register, 48b, 48b-1, 48b-2: second register, 48c, 48c-1, 48c-2, 48e: adder, 48d, 48d-1, 48d-2: third register, 48i: fourth register, 49: detection system, 401: first pixel circuit region, 402: second pixel circuit region, 51: signal line, 61: power transmission line, D1: first data, D2: second data, D3: third data, PS1: first pulse signal, PS2: second pulse signal, R: radiation, Th: threshold value.

1: A radiation detector comprising:
a conversion unit including a plurality of pixels generating carriers in response to incident radiation, the plurality of pixels being arranged along a predetermined direction; and
a plurality of pixel circuits each of which is provided corresponding to each of the plurality of pixels and has at least one detection system configured to read out the carriers from a corresponding pixel of the plurality of pixels,
wherein the at least one detection system includes:
a comparator comparing a first signal based on an amount of the carriers with a threshold value and outputting a second signal when the first signal exceeds the threshold value;
a counter counting the number of second signals, each of which is the second signal;
a first register holding first data which is a count value of the counter;
a second register holding second data;
an adder adding the first data and the second data to generate third data; and
a third register holding the third data, and
the second data is the third data transferred from the third register of a pixel circuit provided corresponding to a pixel adjacent to a corresponding pixel of the plurality of pixels in each of the plurality of pixel circuits.

2: The radiation detector according to claim 1,
wherein the adder includes at least one of the first register, the second register, and the third register, and
the at least one detection system has other registers excluding the at least one of the first register, the second register, and the third register outside the adder.

3: The radiation detector according to claim 1,
wherein, in each of the plurality of pixel circuits, an area of a first region occupied by an analog circuit including the comparator is larger than an area of a second region occupied by a digital circuit including the counter, the first register, the second register, the adder, and the third register.

4: The radiation detector according to claim 3,
wherein the area of the first region is equal to or larger than half of an entire area of each of the plurality of pixel circuits.

5: The radiation detector according to claim 1,
wherein each of the plurality of pixel circuits has a plurality of detection systems as the at least one detection system, and
threshold values in the plurality of detection systems, each of which is the threshold value of the comparator, are different for each detection system.

6: The radiation detector according to claim 5,
wherein adders in the plurality of detection systems, each of which is the adder, are individually provided for each detection system.

7: The radiation detector according to claim 5,
wherein the adder in each of the plurality of detection systems is common to the plurality of detection systems.

8: The radiation detector according to claim 1,
wherein the number of bits of the second register is equal to or larger than a sum of the number of bits of the first register and the number of bits which is a binary representation of the number of the plurality of pixel circuits, and
the number of bits of the adder is equal to the number of bits of the second register.

9: The radiation detector according to claim 1,
wherein the number of bits of the second register is equal to or larger than a sum of the number of bits of the first register and the number of bits which is a binary representation of the number of the plurality of pixel circuits,
the number of bits of the adder is smaller than the number of bits of the second register, and
the adder repeatedly performs an operation of adding some bits of the first data in the first register and some bits of the second data in the second register corresponding to the some bits of the first data and outputting a result of the adding until all of the bits of the first data are added.

10: The radiation detector according to claim 9,
wherein the number of bits of the adder is one, and
the adder has a fourth register for holding a carry signal.

11: The radiation detector according to claim 1,
wherein each of the plurality of pixel circuits further includes a charge sharing countermeasure circuit that, when the carriers generated by an incidence of the radiation are dispersively read out to two or more of pixel circuits of the plurality of pixel circuits, determines a pixel of the plurality of pixels corresponding to a position where the radiation is incident and corrects and evaluates the amount of carriers in the pixel, or ignores the incidence of the radiation.

12: The radiation detector according to claim 1,
wherein the plurality of pixel circuits further include a switching unit for switching between an operation of transferring the third data along the predetermined direction and an operation of transferring the third data along a direction opposite to the predetermined direction.

13: The radiation detector according to claim 1,
wherein each of the plurality of pixel circuits further includes a shaper circuit provided in a stage preceding the comparator, and
the shaper circuit reduces a time constant of the first signal.

14: The radiation detector according to claim 1,
wherein the plurality of pixel circuits have a first pixel circuit region and a second pixel circuit region, and
the first data is stored in the first register at different timings in the first pixel circuit region and the second pixel circuit region.

15: The radiation detector according to claim 14, further comprising:
a power supply supplying a power supply voltage to each of the plurality of pixel circuits through a power transmission line; and
a control unit configured to transmit a hold signal to each of the plurality of pixel circuits through a signal line,
wherein the second pixel circuit region is arranged with the first pixel circuit region along a predetermined direction, and
a direction in which the power transmission line is branched intersects a direction in which the signal line is branched and the predetermined direction.

16: An integrated circuit comprising:
a plurality of pixel circuits each of which is provided corresponding to each of a plurality of pixels generating carriers in response to incident radiation, the plurality of pixels being arranged along a predetermined direction, each of the plurality of pixel circuits having at least one detection system configured to read out the carriers from a corresponding pixel of the plurality of pixels,
wherein the at least one detection system includes:
a comparator comparing a first signal based on an amount of the carriers with a threshold value and outputting a second signal when the first signal exceeds the threshold value;
a counter counting the number of second signals, each of which is the second signal;
a first register holding first data which is a count value of the counter;
a second register holding second data;
an adder adding the first data and the second data to generate third data; and
a third register holding the third data, and
the second data is the third data transferred from the third register of a pixel circuit provided corresponding to a pixel adjacent to a corresponding pixel of the plurality of pixels in each of the plurality of pixel circuits.

17: A radiation detection method comprising:
generating carriers in response to incident radiation in a plurality of pixels arranged along a predetermined direction;
reading out the carriers from a corresponding pixel of the plurality of pixels in a plurality of pixel circuits provided corresponding to the plurality of pixels, respectively;
comparing a first signal based on an amount of the carriers with a threshold value and outputting a second signal when the first signal exceeds the threshold value;
counting the number of second signals, each of which is the second signal;
holding first data, which is a count value in the counting, in a first register;
holding second data in a second register;
adding the first data and the second data to generate third data; and
holding the third data in a third register,
wherein the second data is the third data transferred from the third register of a pixel circuit provided corresponding to a pixel adjacent to a corresponding pixel of the plurality of pixels in each of the plurality of pixel circuits.
